(19) United States
(12) Patent Application Publication
(10) Pub. No.: US 2016/0187795 A1
(43) Pub. Date: Jun. 30, 2016

(54) TONER, DEVELOPER, AND IMAGE FORMING APPARATUS

(71) Applicants: Akinori SAITOH, Shizuoka (JP); Tsuyoshi SUGIMOTO, Shizuoka (JP); Shinsuke NAGAI, Shizuoka (JP); Hiroyuki TAKEDA, Kanagawa (JP); Takahiro KADOTA, Shizuoka (JP); Akihiro TAKEYAMA, Kanagawa (JP)

(72) Inventors: Akinori SAITOH, Shizuoka (JP); Tsuyoshi SUGIMOTO, Shizuoka (JP); Shinsuke NAGAI, Shizuoka (JP); Hiroyuki TAKEDA, Kanagawa (JP); Takahiro KADOTA, Shizuoka (JP); Akihiro TAKEYAMA, Kanagawa (JP)

(21) Appl. No.: 14/979,408

(22) Filed: Dec. 27, 2015

(30) Foreign Application Priority Data
Dec. 26, 2014 (JP) 2014-264606
Jun. 9, 2015 (JP) 2015-116436

(51) Int. Cl. G03G 9/00; C08G 65/08

(52) U.S. Cl. CPC G03G 9/08764; G03G 9/0821; G03G 9/0806

(57) ABSTRACT

Provided is a toner including at least a polyester resin, wherein the polyester resin has a urethane bond and a urea bond, wherein a ratio (B)/(A) between a nitrogen content (A) in a compound that is contained in a pyrolysate of the toner produced when the toner is pyrolyzed from 50° C. to 700° C. and has two isocyanate groups and a nitrogen content (B) in a compound that is contained in the pyrolysate and has one isocyanate group and one amino group satisfies 0.6≦(B)/(A)≦1.3, and wherein a nitrogen content in the surface of the toner is from 0 atom % to 0.9 atom %.

### BACKGROUND OF THE INVENTION

1. Field of the Invention

The present invention relates to a toner, a developer, and an image forming apparatus.

2. Description of the Related Art

In recent years, there has been a need for toners having a small particle diameter and hot offset resistance for high-quality output images, low-temperature fixability for energy saving, and a sufficient heat resistant storage stability for weathering high-temperature, high-humidity conditions during storage or transportation after production. In particular, improvement of low-temperature fixability is very important because power consumption during fixing accounts for much of power consumption during an image forming process.

In order to improve low-temperature fixability and hot offset resistance, there have been proposed various toner producing methods based on polymerization methods for producing toners from an elongation reaction product of a urethane-modified polyester used as a toner binder. Among such proposals, there are proposals for a toner controlled in the amount of a residual organic solvent before aging, and a method for producing the toner, both intended for providing a toner that exhibits a stable low-temperature fixability and hot offset resistance and has an excellent fixing property (see Japanese Patent Application Laid-Open (JP-A) No. 2011-95608).

This literature describes that a ratio (B)/(A) between a nitrogen content (A) in a compound that is contained in a pyrolysate produced when a toner is pyrolyzed and has two or more isocyanate groups and a nitrogen content (B) in a compound that is contained in the pyrolysate and has one or more isocyanate groups and one or more amino groups is in a range of 0.1≦(B)/(A)≦6.

### SUMMARY OF THE INVENTION

However, although a toner containing a polyester resin having a urethane bond or a urea bond is effective for hot offset resistance and heat resistant storage stability, a urethane bond and a urea bond have positive chargeability and inhibit negative chargeability. In particular, a urea bond has a strong positive chargeability. Hence, there is a need for a toner excellent not only in hot offset resistance and heat resistant storage stability, but also in chargeability.

Furthermore, the technique described in the patent literature mentioned above is not sufficient from the standpoint of satisfying chargeability.

The present invention aims to overcome the various conventional problems described above and achieve the object described below. That is, an object of the present invention is to provide a toner excellent in low-temperature fixability, hot offset resistance, heat resistant storage stability, and chargeability.

A solution to the problems described above is as follows.

A toner of the present invention is a toner containing at least a polyester resin. The polyester resin has a urethane bond and a urea bond. A pyrolysate of the toner produced when the toner is pyrolyzed from 50° C. to 700° C. contain a compound having two isocyanate groups and having a nitrogen content (A) and a compound having one isocyanate group and one amino group and having a nitrogen content (B). A ratio (B)/(A) satisfies 0.6≦(B)/(A)≦1.3. A nitrogen content in the surface of the toner is from 0 atom % to 0.9 atom %.

According to the present invention, it is possible to overcome the various conventional problems described above and provide a toner excellent in low-temperature fixability, hot offset resistance, heat resistant storage stability, and chargeability.

### BRIEF DESCRIPTION OF THE DRAWINGS

FIG. 1 is a schematic configuration diagram illustrating an example of an image forming apparatus of the present invention; and

FIG. 2 is a schematic configuration diagram illustrating another example of an image forming apparatus of the present invention.

### DETAILED DESCRIPTION OF THE INVENTION

### (Toner)

A toner of the present invention contains at least a polyester resin, preferably further contains a crystalline polyester resin, and further contains other components such as a colorant as needed.

The toner is a toner containing at least a polyester resin. The polyester resin has a urethane bond and a urea bond. A ratio (B)/(A) between a nitrogen content (A) in a compound that is contained in a pyrolysate of the toner produced when the toner is pyrolyzed from 50° C. to 700° C. and has two isocyanate groups and a nitrogen content (B) in a compound that is contained in the pyrolysate and has one isocyanate group and one amino group satisfies 0.6≦(B)/(A)≦1.3. A nitrogen content in the surface of the toner is from 0 atom % to 0.9 atom %.

Although a toner containing a polyester resin having a urethane bond or a urea bond is effective for hot offset resistance and heat resistant storage stability, a urethane bond and a urea bond have positive chargeability and inhibit negative chargeability. In particular, a urea bond has a strong positive chargeability. Hence, it is preferable to suppress a urea bond ratio in terms of chargeability. However, an excessively low urea bond ratio leads to a poor heat resistant storage stability.

Meanwhile, a urethane bond contained at a high ratio leads to a high melt viscosity and acts adversely to glossiness among image qualities, whereas a urethane bond contained at a low ratio leads to a low melt viscosity and acts adversely to heat resistant storage stability and hot offset resistance.

Hence, the present inventors have given consideration to the ratio between a urea bond and a urethane bond in a toner and specified a urea bond content in the toner by specifying a urea bond ratio by the above-described ratio (B)/(A).

The toner of the present invention having a ratio (B)/(A) in a range of 0.6≦(B)/(A)≦1.3 is excellent in hot offset resistance, heat resistant storage stability, and chargeability.

The urea bond content can be observed from a ratio (B)/(A) between a nitrogen content (A) in a compound produced from pyrolysis and having two isocyanate groups derived from a urethane bond and a nitrogen content (B) in a compound produced from pyrolysis and having one isocyanate group derived from a urea bond and one amino group.

It is preferable that the ratio (B)/(A) between the nitrogen content (A) in the compound having two isocyanate groups and the nitrogen content (B) in the compound having one isocyanate group and one amino group satisfy 0.6≦(B)/(A)≦1.3. When (B)/(A)>1.3, the urea bond ratio is high, and a strong positive chargeability due to the urea bond inhibits negative chargeability. When (B)/(A)≦0.6, the urea bond ratio is low, and there is a poor cross-linking effect available from the urea bond, leading to a poor hot offset resistance and a poor heat resistant storage stability.

### <Method for Measuring Ratio (B)/(A) Between Nitrogen Content (A) in Compound Having Two Isocyanate Groups and Nitrogen Content (B) in Compound Having One Isocyanate Group and One Amino Group>

The ratio (B)/(A) between the nitrogen content (A) in the compound having two isocyanate groups and the nitrogen content (B) in the compound having one isocyanate group and one amino group is measured under the conditions described below.

The toner is weighed out in an amount of 100 μg in a measuring cup, and the cup is capped with inactive wool and set in a pyrolyzer. Pyrolysates produced from the pyrolysis are trapped in liquid nitrogen, are delivered to a gas chromatograph column, and are each separately detected by a nitrogen-phosphorus detector.

The conditions of the devices are as described below.

Gas chromatograph: HP6890 available from Hewlett-Packard Company

Column: ULTRA ALLOY⁺-5

Detector: a nitrogen-phosphorus detector

Pyrolyzer: PY-2020D available from Frontier Laboratories Ltd.

Pyrolyzing temperature: a starting temperature of 50° C., a temperature raising rate of 10° C./min, and an ending temperature of 700° C.

Oven temperature: retained at a starting temperature of 50° C. for 10 minutes, raised up to 250° C. at a temperature raising rate of 5° C./min, and after reaching 250° C., raised up to 300° C. at a temperature raising rate of 25° C./min.

Injection temperature: 320° C.

Amount of the sample: 100 μg

A peak area (S1) of a compound having two or more isocyanate groups and detected by the nitrogen-phosphorus detector and a peak area (S2) of a compound having one or more isocyanate groups and one or more amino groups and detected by the nitrogen-phosphorus detector are calculated.

A ratio (B)/(A) between a nitrogen content (A) in a compound that is contained in a pyrolysate produced when the toner is pyrolyzed from 50° C. to 700° C. and has two or more isocyanate groups and a nitrogen content (B) in a compound that is contained in the pyrolysate and has one or more isocyanate groups and one or more amino groups is calculated according to a formula below.

### <Nitrogen Content in Surface of Toner>

In order to control negative chargeability, there is a need of suppressing an amount of positively chargeable elements in the surface of the toner. In the toner of the present invention having a urethane bond and a urea bond, there is a need of suppressing the abundance of nitrogen having positive chargeability in the surface of the toner. When the nitrogen content in the surface of the toner is from 0 atom % to 0.9 atom %, the toner of the present invention has excellent chargeability.

When the nitrogen content is 0.9 atom % or lower, negative chargeability can be suppressed from being inhibited by the nitrogen in the surface of the toner and a desired effect of the present invention can be obtained.

The nitrogen content in the surface of the toner is measured according to an X-ray photoelectron spectroscopy under the conditions described below.

Measuring instrument: AXIS-ULTRA available from Kratos Analytical Ltd.

Measuring light source: Al (monochrometer)

Measuring output: 105 W (15 kV, 7 mA)

Analyzing area: 900×600 μm²

Measuring mode: Hybrid mode

Pass energy: (wide scan) 160 eV
(narrow scan) 40 eV

Energy step: (wide scan) 1.0 eV
(narrow scan) 0.2 eV

Relative sensitivity coefficient: a relative sensitivity coefficient of Kratos Analytical Ltd. is used.

### <Polyester Resin>

It is preferable that the polyester resin contain a diol component and a cross-linking component as constituent components.

It is preferable that the polyester resin contain an aliphatic diol having 3 to 12 carbon atoms as the diol component. It is preferable that the polyester resin contain the aliphatic diol in an amount of preferably equal to or greater than 50 mol %, more preferably equal to or greater than 80 mol %, and yet more preferably equal to or greater than 90 mol % of the diol component.

It is preferable that the polyester resin contain a trihydric or higher aliphatic alcohol as the cross-linking component.

Example methods conceivable for improving low-temperature fixability include a method for suppressing a glass transition temperature of a polyester resin (e.g., an amorphous polyester resin) or a method for suppressing a molecular weight of the polyester resin, with a view to enabling the polyester resin to be melted together with a crystalline polyester resin. However, it is easily imagined that if a melt viscosity of the polyester resin was suppressed simply by suppressing the glass transition temperature or the molecular weight of the polyester resin, heat resistant storage stability of the toner and a hot offset property of the toner during fixing would be degraded.

In this regard, in the toner of the present invention, it is preferable that the polyester resin contain a diol component as a constituent component, and that equal to or greater than 50 mol % of the diol component be an aliphatic diol having 3 to 12 carbon atoms. This suppresses the glass transition temperature and melt viscosity and ensures low-temperature fixability. In addition, it is preferable that the polyester resin contain a trihydric or higher aliphatic alcohol as a cross-linking component. This ensures the polyester resin a molecular skeleton having a branched structure and hence a molecular chain having a three-dimensional network structure. Therefore, the polyester resin has a rubber-like property of being deformable at a low temperature without being fluidized. This enables the toner to have heat resistant storage stability and hot offset resistance.

Here, it may be possible to use a trivalent or higher carboxylic acid, epoxy, etc. as the cross-linking component. However, use of a carboxylic acid may not lead to sufficient expression of glossiness over a fixed image produced by heating and fixing the toner, because a carboxylic acid is an aromatic compound in many cases or because a carboxylic acid makes an ester bond density at a cross-linked site high. Use of a cross-linking agent such as epoxy may not lead to achievement of a desired viscoelasticity because this needs a cross-linking reaction to be induced after a polyester resin is polymerized, making it difficult to control the distance between cross-linking points. Further, use of a cross-linking agent such as epoxy may lead to unevenness in a fixed image, a poor glossiness, and a poor image density, because such a cross-linking agent tends to produce a highly densely cross-linked moiety that results from a reaction with an oligomer during production of a polyester.

The polyester resin contains a diol component and a cross-linking component as constituent components, and more preferably further contains a dicarboxylic acid component as a constituent component.

The polyester resin is preferably an amorphous polyester resin.

Examples of the aliphatic diol having 3 to 12 carbon atoms include 1,3-propanediol, 1,4-butanediol, 2-methyl-1,3-propanediol, 1,5-pentanediol, 3-methyl-1,5-pentanediol, 1,6-hexanediol, 1,8-octanediol, 1,10-decanediol, and 1,12-dodecanediol.

In particular, it is preferable that the diol component be an aliphatic diol that has 4 to 12 carbon atoms, has an odd number of carbon atoms at a main-chain moiety of the diol component, and has an alkyl group on a side chain of the diol component.

Examples of an aliphatic diol that has 4 to 12 carbon atoms, has an odd number of carbon atoms at a main-chain moiety of the diol component, and has an alkyl group on a side chain of the diol component include aliphatic diols represented by a general formula (1) below.

HO—(CR¹R²)ₙ—OH General Formula (1)

In the general formula (1) above, R¹ and R² each independently represent a hydrogen atom and an alkyl group having 1 to 3 carbon atoms. n represents an odd number of from 3 to 9. In the n repeating units, R² may be the same or varied.

In the polyester resin, it is preferable that the cross-linking component contain a trihydric or higher aliphatic alcohol, in particular, a trihydric or tetrahydric aliphatic alcohol, in terms of glossiness and image density of a fixed image. It is also possible that the cross-linking component contain only the trihydric or higher aliphatic alcohol.

Examples of the trihydric or higher aliphatic alcohol include glycerin, trimethylolethane, trimethylolpropane, pentaerythritol, sorbitol, and dipentaerythritol.

A ratio of the cross-linking component in the constituent components of the polyester resin is not particularly limited and may be appropriately selected according to the purpose. However, the ratio of the cross-linking component is preferably from 0.5% by mass to 5% by mass, and more preferably from 1% by mass to 3% by mass.

A ratio of the trihydric or higher aliphatic alcohol in a multihydric alcohol component which is a constituent component of the polyester resin is not particularly limited and may be appropriately selected. However, the ratio of the trihydric or higher aliphatic alcohol is preferably from 50% by mass to 100% by mass, and more preferably from 90% by mass to 100% by mass.

In order to suppress Tg of the polyester resin and make it easier for the polyester resin to have a property of deforming at a low temperature, it is preferable that the polyester resin contain a dicarboxylic acid component as a constituent component, and that the dicarboxylic acid component be an aliphatic dicarboxylic acid having 4 to 12 carbon atoms.

It is preferable that the polyester resin contains of the aliphatic dicarboxylic acid having 4 to 12 carbon atoms in an amount of 50 mol % or greater but less than 60 mol %.

Examples of the aliphatic dicarboxylic acid having 4 to 12 carbon atoms include a succinic acid, a glutaric acid, an adipic acid, a pimelic acid, a suberic acid, an azelaic acid, a sebacic acid, and a dodecanedioic acid.

The polyester resin has a urethane bond and a urea bond.

A polyester resin having a urethane bond and a urea bond can be produced by reacting an active hydrogen group of a polyester resin with a polyisocyanate to obtain a reaction product (hereinafter may be referred to also as “prepolymer”) and then reacting the reaction product by water, as will be described below.

The polyester resin has a urethane bond and a urea bond. Hence, the urethane bond or the urea bond behaves as a quasi-cross-linking point and enhances a rubber-like property of the polyester resin. This makes it possible to produce a toner excellent in heat resistant storage stability and hot offset resistance.

The polyester resin may be used alone, or may be used in combination with any other polyester resin.

The any other polyester resin contains, for example, a diol component and a dicarboxylic acid component as constituent components. The any other polyester resin may or may not contain an aliphatic diol having 3 to 12 carbon atoms as a constituent component. The any other polyester resin may or may not contain the cross-linking component as a constituent component.

The any other polyester resin may be an unmodified polyester resin. An unmodified polyester resin refers to a polyester resin that is not modified with an isocyanate compound or the like.

### —Diol Component—

The diol component is not particularly limited, and an arbitrary diol component may be selected according to the purpose. Examples of the diol component include: aliphatic diols such as ethylene glycol, 1,2-propylene glycol, 1,3-propylene glycol, 1,4-butanediol, 2-methyl-1,3-propanediol, 1,5-pentanediol, 3-methyl-1,5-pentanediol, 1,6-hexanediol, 1,8-octanediol, 1,10-decanediol, and 1,12-dodecanediol; diols having an oxyalkylene group, such as diethylene glycol, triethylene glycol, dipropylene glycol, polyethylene glycol, polypropylene glycol, and polytetramethylene glycol; alicyclic diols such as 1,4-cyclohexane dimethanol and hydrogenated bisphenol A; alkylene oxide adducts such as ethylene oxide adducts, propylene oxide adducts, and butylene oxide adducts of alicyclic diols; bisphenols such as bisphenol A, bisphenol F, and bisphenol S; alkylene oxide adducts of bisphenols such as alkylene oxide adducts including ethylene oxide adducts, propylene oxide adducts, and butylene oxide adducts of bisphenols. Among these, an aliphatic diol having 4 to 12 carbon atoms is preferable.

One of these diols may be used alone, or two or more of these diols may be used in combination.

### —Dicarboxylic Acid Component—

The dicarboxylic acid component is not particularly limited, and an arbitrary dicarboxylic acid component may be selected according to the purpose. Examples of the dicarboxylic acid component include an aliphatic dicarboxylic acid and an aromatic dicarboxylic acid. Anhydrides, lower (C1 to C3) alkyl esters, and halides of these acids may also be used.

The aliphatic dicarboxylic acid is not particularly limited, and an arbitrary aliphatic dicarboxylic acid may be selected according to the purpose. Examples of the aliphatic dicarboxylic acid include a succinic acid, an adipic acid, a sebacic acid, a dodecanedioic acid, a maleic acid, and a fumaric acid.

The aromatic dicarboxylic acid is not particularly limited, and an arbitrary aromatic dicarboxylic acid may be selected according to the purpose. However, an aromatic dicarboxylic acid having 8 to 20 carbon atoms is preferable.

The aromatic dicarboxylic acid having 8 to 20 carbon atoms is not particularly limited, and an arbitrary aromatic dicarboxylic acid having 8 to 20 carbon atoms may be selected according to the purpose. Examples of the aromatic dicarboxylic acid having 8 to 20 carbon atoms include a phthalic acid, an isophthalic acid, a terephthalic acid, and a naphthalene dicarboxylic acid.

Among these, an aliphatic dicarboxylic acid having 4 to 12 carbon atoms is preferable.

One of these dicarboxylic acids may be used alone, or two or more of these may be used in combination.

### —Trihydric or Higher Aliphatic Alcohol—

The trihydric or higher aliphatic alcohol is not particularly limited, and an arbitrary trihydric or higher aliphatic alcohol may be selected according to the purpose. Examples of the trihydric or higher aliphatic alcohol include glycerin, trimethylolethane, trimethylolpropane, pentaerythritol, and sorbitol.

Among these, a trihydric to tetrahydric aliphatic alcohol is preferable. One of these trihydric or higher aliphatic alcohols may be used alone, or two or more of these may be used in combination.

### <<Polyester Resin Having Urethane Bond and Urea Bond>>

It is preferable that the polyester resin having a urethane bond and a urea bond be a product obtained by reacting by water, a reaction product obtained by reacting an active hydrogen group of the polyester resin with a polyisocyanate.

Examples of the active hydrogen group of the polyester resin include a hydroxyl group.

### —Polyisocyanate—

The polyisocyanate is not particularly limited, and an arbitrary polyisocyanate may be selected according to the purpose. Examples of the polyisocyanate include diisocyanate and trivalent or higher isocyanate.

Examples of the diisocyanate include an aliphatic diisocyanate, an alicyclic diisocyanate, an aromatic diisocyanate, an aromatic aliphatic diisocyanate, isocyanurates, and products obtained by blocking these with a phenol derivative, oxime, caprolactam, etc.

Examples of the trivalent or higher isocyanate include lysine triisocyanate or a product obtained by reacting a trihydric or higher alcohol with a diisocyanate.

The aliphatic diisocyanate is not particularly limited, and an arbitrary aliphatic diisocyanate may be selected according to the purpose. Examples of the aliphatic diisocyanate include tetramethylene diisocyanate, hexamethylene diisocyanate, methyl-2,6-diisocyanato caproate, octamethylene diisocyanate, decamethylene diisocyanate, dodecamethylene diisocyanate, tetradecamethylene diisocyanate, trimethylhexane diisocyanate, and tetramethylhexane diisocyanate.

The alicyclic diisocyanate is not particularly limited, and an arbitrary alicyclic diisocyanate may be selected according to the purpose. Examples of the alicyclic diisocyanate include isophorone diisocyanate and cyclohexylmethane diisocyanate.

The aromatic diisocyanate is not particularly limited, and an arbitrary aromatic diisocyanate may be selected according to the purpose. Examples of the aromatic diisocyanate include tolylene diisocyanate, diisocyanato diphenyl methane, 1,5-naphthylene diisocyanate, 4,4′-diisocyanato diphenyl, 4,4′-diisocyanato-3,3′-dimethyl diphenyl, 4,4′-diisocyanato-3-methyl diphenyl methane, and 4,4′-diisocyanato-diphenyl ether.

The aromatic aliphatic diisocyanate is not particularly limited, and an arbitrary aromatic aliphatic diisocyanate may be selected according to the purpose. Examples of the aromatic aliphatic diisocyanate include α,α,α′,α′-tetramethyl xylylene diisocyanate.

The isocyanurates are not particularly limited, and an arbitrary isocyanurate may be selected according to the purpose. Examples of the isocyanurates include tris(isocyanatoalkyl)isocyanurate and tris(isocyanatocycloalkyl)isocyanurate.

One of these polyisocyanates may be used alone, or two or more of these may be used in combination.

### —Reaction by Water—

It is preferable that a prepolymer which is a reaction product between an active hydrogen group of the polyester resin and a polyisocyanate be cross-linked to a urea by water. This results in a smaller number of urea groups than the number of urea groups produced from commonly-known cross-linking by diamine, and can suppress inhibition on chargeability.

In order to obtain a (B)/(A) value in the desired range, it is preferable to adjust conditions of aging performed after an emulsifying/desolventizing step in a toner producing process, as will be described below.

The polyester resin of the present invention may include two or more kinds of polyester resins, and may include any other polyester resin than the polyester resin having a urethane bond and a urea bond.

### <<Any Other Polyester Resin>>

The any other polyester resin contain, for example, a diol component and a dicarboxylic acid component as constituent components.

The any other polyester resin refers to a polyester resin of a different kind from the polyester resin having a urethane bond and a urea bond. Hence, the any other polyester resin is preferably a polyester resin free of a urethane bond or a urea bond.

The any other polyester resin is preferably an amorphous polyester resin, and more preferably an unmodified polyester resin.

The unmodified polyester resin refers to a polyester resin that is produced from a multihydric alcohol and a multivalent carboxylic acid such as a multivalent carboxylic acid, a multivalent carboxylic acid anhydride, and a multivalent carboxylate ester, or a derivative of the multivalent carboxylic acid, and that is not modified with an isocyanate compound or the like.

Examples of the multihydric alcohol include a diol.

Examples of the diol include: alkylene (C2 to C3) oxide adducts (with an average of from 1 mole to 10 moles added) of bisphenol A, such as polyoxypropylene (2.2)-2,2-bis(4-hydroxyphenyl)propane and polyoxyethylene (2.2)-2,2-bis(4-hydroxyphenyl)propane; ethylene glycol and propylene glycol; hydrogenated bisphenol A; and alkylene (C2 to C3) oxide adducts (with an average of from 1 mole to 10 moles added) of hydrogenated bisphenol A.

One of these may be used alone, or two or more of these may be used in combination.

Examples of the multivalent carboxylic acid include a dicarboxylic acid.

Examples of the dicarboxylic acid include: an adipic acid, a phthalic acid, an isophthalic acid, a terephthalic acid, a fumaric acid, and a maleic acid; and succinic acids in which an alkyl group having 1 to 20 carbon atoms or an alkenyl group having 2 to 20 carbon atoms is substituted, such as a dodecenyl succinic acid and an octyl succinic acid.

One of these may be used alone, or two or more of these may be used in combination.

The molecular structure of the polyester resin (including both of the case where one kind of a polyester resin is used and the case where any other polyester resin is used in combination) can be observed by NMR measurement with a solution or a solid, X-ray diffraction, GC/MS, LC/MS, IR measurement, etc. A simple method for the observation is a method for detecting as a polyester resin, a component that does not exhibit absorption based on δCH (out-of-plane bending vibration) of olefin at 965±10 cm⁻¹ and at 990±10 cm⁻¹ in the infrared absorption spectrum.

The content of the polyester resin is not particularly limited, and may be appropriately selected according to the purpose. However, the content is preferably from 50 parts by mass to 90 parts by mass, and more preferably from 70 parts by mass to 85 parts by mass relative to 100 parts by mass of the toner. When the content is 50 parts by mass or greater, it is possible to prevent degradation of low-temperature fixability and hot offset resistance. When the content is 90 parts by mass or less, it is possible to prevent degradation of heat resistant storage stability, and degradation of a gloss level and a colored level of an image resulting from fixing. A content in the more preferable range is advantageous in that all of low-temperature fixability, hot offset resistance, and heat resistant storage stability will be excellent.

### <Crystalline Polyester Resin>

The crystalline polyester resin has crystallinity, and hence exhibits a heat melting characteristic having a sharp viscosity drop around a fixing start temperature. When used in combination with the polyester resin described above, the crystalline polyester resin having this characteristic keeps a good heat resistant storage stability until immediately before a melting start temperature owing to the crystallinity, melts and causes a sharp viscosity drop (sharp melting) at the melting start temperature, and at the same time becomes compatibilized with the polyester resin described above. This causes both of the resins to have a sharp viscosity drop and to be fixed. Hence, a toner having a favorable heat resistant storage stability and a favorable low-temperature fixability at the same time can be obtained. This toner also has a favorable result in terms of a release width (i.e., a difference between the lowest fixable temperature and a temperature at which hot offset occurs).

The crystalline polyester resin can be produced from a multihydric alcohol and a multivalent carboxylic acid such as a multivalent carboxylic acid, a multivalent carboxylic acid anhydride, and a multivalent carboxylate ester, or a derivative of the multivalent carboxylic acid.

In the present invention, a crystalline polyester resin refers to a resin produced from a multihydric alcohol and a multivalent carboxylic acid such as a multivalent carboxylic acid, a multivalent carboxylic acid anhydride, and a multivalent carboxylate ester, or a derivative of the multivalent carboxylic acid as described above. Modified polyester resins, e.g., the prepolymer described above and a resin produced from a cross-linking reaction, an elongation reaction, or both of the prepolymer do not belong to the crystalline polyester resin.

Whether the crystalline polyester resin of the present invention has crystallinity can be confirmed with a crystal diffraction X-ray diffractometer (e.g., X' PERT PRO MRD available from Philips Co., Ltd.). A measuring method will be described below.

First, a target sample is ground in a mortar to produce a ground sample powder. The obtained sample powder is applied uniformly over a sample holder. After this, the sample holder is set in the diffractometer for the measurement, to obtain a diffraction spectrum.

When a peak observed in a range of 20°<2θ<25° and having a highest peak intensity has a peak half value width of 2.0 or less, the target sample is judged to have crystallinity.

In the present invention, a polyester resin that does not exhibit such a condition is referred to as amorphous polyester resin as compared with crystalline polyester resin.

Conditions for the X-ray diffraction measurement are described below.

### [Conditions for Measurement]

Tension kV: 45 kV

Current: 40 mA

MPSS

Upper

Gonio

Scanmode: continuous

Start angle: 3°

End angle: 350

Angle Step: 0.02°

Lucident beam optics

Divergence slit: Div slit ½

Difflection beam optics

Anti scatter slit: As Fixed ½

Receiving slit: Prog rec slit

### —Multihydric Alcohol—

The multihydric alcohol is not particularly limited, and an arbitrary multihydric alcohol may be selected according to the purpose. Examples of the multihydric alcohol include a diol and a trihydric or higher alcohol.

Examples of the diol include a saturated aliphatic diol. Examples of the saturated aliphatic diol include a straight-chain saturated aliphatic diol and a branched saturated aliphatic diol. Of these, a straight-chain saturated aliphatic diol is preferable, and a straight-chain saturated aliphatic diol having 2 to 12 carbon atoms is more preferable. When the saturated aliphatic diol has a straight chain, the crystalline polyester resin can be suppressed from degradation of crystallinity and lowering of the melting point. The carbon number of the saturated aliphatic diol is more preferably 12 or less in terms of availability of the material.

Examples of the saturated aliphatic diol include ethylene glycol, 1,3-propanediol, 1,4-butanediol, 1,5-pentanediol, 1,6-hexanediol, 1,7-heptanediol, 1,8-octanediol, 1,9-nonanediol, 1,10-decanediol, 1,11-undecanediol, 1,12-dodecanediol, 1,13-tridecanediol, 1,14-tetradecanediol, 1,18-octadecanediol, and 1,14-eicosane decanediol. Among these, ethylene glycol, 1,4-butanediol, 1,6-hexanediol, 1,8-octanediol, 1,10-decanediol, and 1,12-dodecanediol are preferable because these impart a high crystallinity and an excellent sharp melting property to the crystalline polyester resin.

Examples of the trihydric or higher alcohol include glycerin, trimethylolethane, trimethylolpropane, and pentaerythritol. One of these may be used alone, or two or more of these may be used in combination.

### —Multivalent Carboxylic Acid—

The multivalent carboxylic acid is not particularly limited, and an arbitrary multivalent carboxylic acid may be selected according to the purpose. Examples of the multivalent carboxylic acid include a divalent carboxylic acid and a trivalent or higher carboxylic acid.

Examples of the divalent carboxylic acid include: saturated aliphatic dicarboxylic acids such as an oxalic acid, a succinic acid, a glutaric acid, an adipic acid, a suberic acid, an azelaic acid, a sebacic acid, a 1,9-nonane dicarboxylic acid, a 1,10-decane dicarboxylic acid, a 1,12-dodecane dicarboxylic acid, a 1,14-tetradecane dicarboxylic acid, and a 1,18-octadecane dicarboxylic acid; aromatic dicarboxylic acids such as a phthalic acid, an isophthalic acid, a terephthalic acid, a naphthalene-2,6-dicarboxylic acid, a malonic acid, and a dibasic acid such as a mesaconic acid; and anhydrides and lower (C1 to C3) alkyl esters of these acids.

Examples of the trivalent or higher carboxylic acid include a 1,2,4-benzene tricarboxylic acid, a 1,2,5-benzene tricarboxylic acid, and a 1,2,4-naphthalene tricarboxylic acid, and anhydrides and lower (C1 to C3) alkyl esters of these acids.

Other than the saturated aliphatic dicarboxylic acid and the aromatic dicarboxylic acid, a dicarboxylic acid having a sulfonic acid group may be contained as the multivalent carboxylic acid. Furthermore, other than the saturated aliphatic dicarboxylic acid and the aromatic dicarboxylic acid, a dicarboxylic acid having a double bond may be contained as the multivalent carboxylic acid. One of these may be used alone, or two or more of these may be used in combination.

It is preferable that the crystalline polyester resin be made of a straight-chain saturated aliphatic dicarboxylic acid having 4 to 12 carbon atoms and a straight-chain saturated aliphatic diol having 2 to 12 carbon atoms. That is, it is preferable that the crystalline polyester resin contain a constituent unit derived from a saturated aliphatic dicarboxylic acid having 4 to 12 carbon atoms and a constituent unit derived from a saturated aliphatic diol having 2 to 12 carbon atoms. This is preferable because these constituent units impart a high crystallinity and an excellent sharp melting property to the crystalline polyester resin and make it possible for the crystalline polyester resin to exhibit excellent low-temperature fixability.

A melting point of the crystalline polyester resin is not particularly limited, and may be appropriately selected according to the purpose. However, the melting point is preferably from 60° C. to 80° C. When the melting point is 60° C. or higher, the crystalline polyester resin can be prevented from melting at a low temperature, and the toner can be prevented from degradation of heat resistant storage stability. When the melting point is 80° C. or lower, the crystalline polyester resin can be secured to melt sufficiently by heating during fixing, and degradation of low-temperature fixability can be prevented.

A molecular weight of the crystalline polyester resin is not particularly limited, and may be appropriately selected according to the purpose. However, it is preferable that an orthodichlorobenzene-soluble component of the crystalline polyester resin have a weight average molecular weight (Mw) of from 3,000 to 30,000, a number average molecular weight (Mn) of from 1,000 to 10,000, and Mw/Mn of from 1.0 to 10 when measured by GPC, from viewpoints that a crystalline polyester resin having a sharp molecular weight distribution and a low molecular weight has excellent low-temperature fixability and that a crystalline polyester resin containing a low-molecular-weight component in a large amount has a poor heat resistant storage stability. The weight average molecular weight (Mw) is more preferably from 5,000 to 15,000, the number average molecular weight (Mn) is more preferably from 2,000 to 10,000, and Mw/Mn is more preferably from 1.0 to 5.0.

An acid value of the crystalline polyester resin is not particularly limited, and may be appropriately selected according to the purpose. However, the acid value is preferably 5 mgKOH/g or higher, and more preferably 10 mgKOH/g or higher in order to achieve a desired low-temperature fixability in terms of affinity between paper and the resin. On the other hand, the acid value is preferably 45 mgKOH/g or lower in order to improve hot offset resistance.

A hydroxyl value of the crystalline polyester resin is not particularly limited, and may be appropriately selected according to the purpose. However, the hydroxyl value is preferably from 0 mgKOH/g to 50 mgKOH/g, and more preferably from 5 mgKOH/g to 50 mgKOH/g in order to achieve a desired low-temperature fixability and a favorable charging property.

The molecular structure of the crystalline polyester resin can be observed by NMR measurement with a solution or a solid, X-ray diffraction, GC/MS, LC/MS, IR measurement, etc. A simple method for the observation is a method for detecting as a crystalline polyester resin, a component that exhibits absorption based on δCH (out-of-plane bending vibration) of olefin at 965±10 cm⁻¹ or at 990±10 cm⁻¹ in the infrared absorption spectrum.

A content of the crystalline polyester resin is not particularly limited, and may be appropriately selected according to the purpose. However, the content is preferably from 3 parts by mass to 20 parts by mass, and more preferably from 5 parts by mass to 15 parts by mass relative to 100 parts by mass of the toner. When the content is 3 parts by mass or greater, there is a sufficient sharp melting property available from the crystalline polyester resin, and this secures low-temperature fixability. When the content is 20 parts by mass or less, problems such as degradation of heat resistant storage stability and image fogging do not occur. A content in the more preferably range advantageous in that all of image quality and low-temperature fixability will be excellent.

### <Other Components>

Examples of the other components include a release agent, a colorant, a charge controlling agent, an external additive, a flowability improver, a cleanability improver, and a magnetic material.

### —Release Agent—

The release agent is not particularly limited, and an arbitrary release agent may be selected from publicly known release agents.

Examples of brazing materials and waxes as the release agent include natural waxes including: vegetable waxes such as a carnauba wax, a cotton wax, a Japan tallow, and a rice wax; animal waxes such as a beeswax and lanolin; mineral waxes such as ozokerite and ceresin; and petroleum waxes such as paraffin, microcrystalline, and petrolatum.

Examples of the release agent other than these natural waxes include: synthetic hydrocarbon waxes such as a Fischer-Tropsch wax, polyethylene, and polypropylene; and synthetic waxes such as esters, ketones, and ethers.

A content of the release agent is not particularly limited, and may be appropriately selected according to the purpose. However, the content is preferably from 2 parts by mass to 10 parts by mass, and more preferably from 3 parts by mass to 8 parts by mass relative to 100 parts by mass of the toner.

### —Colorant—

The colorant is not particularly limited, and an arbitrary colorant may be selected according to the purpose. Examples of the colorant include black pigments, yellow pigments, magenta pigments, and cyan pigments.

A content of the colorant is not particularly limited, and may be appropriately selected according to the purpose. However, the content is preferably from 1 part by mass to 15 parts by mass, and more preferably from 3 parts by mass to 10 parts by mass relative to 100 parts by mass of the toner.

The colorant may be used in the form of a master batch in which the colorant is combined with a resin. Examples of the resin produced as a master batch or kneaded with a master batch include the any other polyester resin described above and polymers of styrene or styrene substitutes, such as polystyrene, poly p-chlorostyrene, and polyvinyl toluene. An arbitrary resin may be selected according to the purpose.

The master batch can be produced by mixing and kneading the resin for master batch and the colorant under a high shearing force. For the mixing and kneading, an organic solvent may be used in order to enhance interaction between the colorant and the resin. A so-called flushing method for mixing and kneading a water-containing aqueous paste of the colorant and the resin together with an organic solvent to transfer the colorant to the resin and then removing the water component and the organic solvent component is preferable because this method can use a wet cake of the colorant as it is without drying.

### —Charge Controlling Agent—

The charge controlling agent is not particularly limited, and an arbitrary charge controlling agent may be selected according to the purpose. Examples of the charge controlling agent include a triphenyl methane-based dye, a chromium-containing metal complex dye, a molybdic acid chelate pigment, a rhodamine-based dye, an alkoxy-based amine, a quaternary ammonium salt (including a fluorine-modified quaternary ammonium salt), an alkylamide, phosphorus or a phosphorus compound, tungsten or a tungsten compound, a fluorine-based active agent, a metal salt of a salicylic acid, and a metal salt of a salicylic acid derivative.

A content of the charge controlling agent is not particularly limited, and may be appropriately selected according to the purpose. However, the content is preferably from 0.1 parts by mass to 10 parts by mass, and more preferably from 0.2 parts by mass to 5 parts by mass relative to 100 parts by mass of the toner.

### —External Additive—

As the external additive, oxide particles may be used, and inorganic particles or hydrophobized inorganic particles may be used in combination. An average particle diameter of hydrophobized primary particles is preferably from 1 nm to 100 nm, and more preferably from 5 nm to 700 nm.

The external additive is not particularly limited, and an arbitrary external additive may be selected according to the purpose. Examples of the external additive include silica particles, hydrophobic silica, fatty acid metal salts (e.g., zinc stearate and aluminium stearate), metal oxides (e.g., titania, alumina, tin oxide, and antimony oxide), and a fluoropolymer.

Preferable examples of the external additive include hydrophobized silica, titania, titanium oxide, and alumina particles.

A content of the external additive is not particularly limited, and may be appropriately selected according to the purpose. However, the content is preferably from 0.1 parts by mass to 5 parts by mass, and more preferably from 0.3 parts by mass to 3 parts by mass relative to 100 parts by mass of the toner.

### —Flowability Improver—

The flowability improver is not particularly limited, and an arbitrary flowability improver may be selected according to the purpose so long as such a flowability improver can increase hydrophobicity of a substance that is surface-treated with the flowability improver and prevent degradation of flowability and a charging property of the surface-treated substance under high-humidity conditions. Examples of the flowability improver include a silane coupling agent, a silylating agent, a silane coupling agent having an alkyl fluoride group, an organic titanate-based coupling agent, an aluminium-based coupling agent, silicone oils, and modified silicone oils. It is particularly preferable that the silica and titanium oxide mentioned above be surface-treated with such a flowability improver and used as hydrophobic silica and hydrophobic titanium oxide.

### —Cleanability Improver—

The cleanability improver is not particularly limited, and an arbitrary cleanability improver may be selected according to the purpose so long as such a cleanability improver is added in the toner in order that a developer remaining over a photoconductor or a first transfer medium after transferring can be removed. Examples of the cleanability improver include fatty acid metal salts such as zinc stearate, calcium stearate, and a stearic acid and polymer particles produced by soap-free emulsion polymerization such as polymethyl methacrylate particles and polystyrene particles.

### —Magnetic Material—

The magnetic material is not particularly limited, and an arbitrary magnetic material may be selected according to the purpose. Examples of the magnetic material include an iron powder, magnetite, and ferrite. Among these, a white magnetic material is preferable in terms of color tone.

### <Glass Transition Temperature (Tg1st)>

A glass transition temperature (Tg1st) of the toner observed at a first temperature raise in differential scanning calorimetry (DSC) is preferably from 20° C. to 50° C., and more preferably from 25° C. to 50° C.

Conventional toners having Tg of about 50° C. or lower tend to agglomerate during transportation of the toners in summertime or in tropical regions, or upon a temperature change in storage conditions. As a result, the toners solidify in a toner bottle or adhere to the interior of a developing device. Furthermore, the toners clog the toner bottle to cause a replenishment failure or adhere to the interior of the developing device to produce abnormal images.

The toner of the present invention has Tg lower than Tg of the conventional toners. Nevertheless, the toner of the present invention can maintain heat resistant storage stability because the polyester resin that is the low Tg component in the toner has a nonlinear shape. In particular, the effect of maintaining heat resistant storage stability is more outstanding when the polyester resin has a urethane bond or a urea bond having a high cohesive force.

A glass transition temperature (Tg2nd) of the toner observed at a second temperature raise in differential scanning calorimetry (DSC) is not particularly limited, and may be appropriately selected according to the purpose. However, the glass transition temperature (Tg2nd) is preferably from 0° C. to 30° C., and more preferably from 10° C. to 30° C.

A difference (Tg1st−Tg2nd) between the glass transition temperature (Tg1st) of the toner observed at the first temperature raise and the glass transition temperature (Tg2nd) of the toner observed at the second temperature raise in differential scanning calorimetry (DSC) is not particularly limited, and may be appropriately selected according to the purpose. However, the difference (Tg1st−Tg2nd) is preferably greater than 0° C. (i.e., Tg1st>Tg2nd), and more preferably 10° C. or more. The upper limit of the difference is not particularly limited, and may be appropriately selected according to the purpose. However, the difference (Tg1st−Tg2nd) is preferably 50° C. or less.

When the toner of the present invention contains a crystalline polyester resin, the crystalline polyester resin and the polyester resin described above that are present in a non-compatibilized state before heating (before the first temperature raise) become compatibilized after heating (after the first temperature raise).

When Tg1st is lower than 20° C., the toner has a poor heat resistant storage stability, and causes blocking in a developing device and filming over a photoconductor. When Tg1st is higher than 50° C., the toner has a poor low-temperature fixability.

When Tg2nd is lower than 0° C., a fixed image (printed matter) has a poor blocking resistance. When Tg2nd is higher than 30° C., a sufficient low-temperature fixability and a sufficient glossiness may not be obtained.

### <Volume Average Particle Diameter>

A volume average particle diameter of the toner is not particularly limited, and may be appropriately selected according to the purpose. However, it is preferably from 3 μm to 7 μm. A ratio of the volume average particle diameter to a number average particle diameter is preferably 1.2 or less. Further, it is preferable that the toner contains a component having a volume average particle diameter of 2 μm or less in an amount of from 1 number % to 10 number %.

### <Methods for Calculating and Analyzing Various Properties of Toner and Toner Constituent Components>

The Tg, acid value, hydroxyl value, molecular weight, and melting point of the polyester resin, the crystalline polyester resin, and the release agent may be measured individually. However, it is also possible to separate each component from the actual toner by gel permeation chromatography (GPC) or the like, and calculate the Tg, molecular weight, and melting point of each separate component and a mass ratio of the constituent components by analyzing each component according to a method described below.

GPC separation into each component may be performed according to the method described below, for example.

In a GPC measurement in which tetrahydrofuran (THF) is a mobile phase, an eluate is collected in fractions with a fraction collector or the like, and fractions corresponding to a desired molecular weight portion in the total surface integral of the eluation curve are collected in one.

The eluate collected in one is condensed and dried with an evaporator or the like, and a resulting solid component is dissolved in a deuterated solvent such as heavy chloroform and heavy THF and subjected to a ¹H-NMR measurement. From integrated ratios of the respective elements, the ratio among the monomers constituting the resin in the eluted component is calculated.

In another manner, an eluate is condensed and hydrolyzed with sodium hydroxide or the like, and a hydrolysate is subjected to a qualitative/quantitative analysis by high-performance liquid chromatography (HPLC) or the like to calculate the ratio among the constituent monomers.

When the toner is produced according to the method for producing the polyester resin by an elongation reaction, a cross-linking reaction, or both of the reaction product having the nonlinear shape by water to produce toner base particles, Tg and the like of the polyester resin may be obtained after the polyester resin is separated from the actual toner by GPC or the like, or Tg and the like of the polyester resin may be measured after the polyester resin is synthesized from an elongation reaction, a cross-linking reaction, or both between the reaction product having the nonlinear shape and water.

### <<Method for Separating Toner Constituent Components>>

An example method for separating each component in analyzing the toner will be described in detail.

First, 1 g of the toner is put into 100 mL of THF and stirred at 25° C. for 30 minutes to obtain a solution in which a soluble component is dissolved.

The solution is filtered through a membrane filter having a mesh size of 0.2 μm to obtain the THF-soluble component of the toner.

Next, the obtained THF-soluble component is dissolved in THF to prepare a sample for GPC measurement, and the sample is injected into a GPC used for measuring the molecular weight of each resin described above.

Meanwhile, a fraction collector is set at a discharging port of the GPC from which an eluate is discharged, and the eluate is collected in fractions at each predetermined counts. The eluate is collected at each 5% by area from the start of eluation of the eluation curve (i.e., the rise of the curve).

Next, 30 mg of each eluate fraction is dissolved as a sample in a 1 mL of heavy chloroform, to which 0.05% by volume of tetramethyl silane (TMS) is added as a reference substance.

The eluate is filled in a glass tube for NMR measurement, and integrated a hundred and twenty eight times with a nuclear magnetic resonator (JNM-AL400 available from JEOL Ltd.) at a temperature of from 23° C. to 25° C. to obtain a spectrum.

The monomer composition such as the polyester resin and the crystalline polyester resin contained in the toner and the component ratio can be obtained from integrated ratios of peaks in the obtained spectrum.

For example, the peaks are attributed in the manner described below, and the componential ratio among the constituent monomers is calculated from integrated ratios of the respective components.

The peaks are attributed as follows, for example:

Around 8.25 ppm: attributed to a benzene ring of a trimellitic acid (corresponding to 1 hydrogen atom)

Around from 8.07 ppm to 8.10 ppm: attributed to a benzene ring of a terephthalic acid (corresponding to 4 hydrogen atoms)

Around from 7.1 ppm to 7.25 ppm: attributed to a benzene ring of bisphenol A (corresponding to 4 hydrogen atoms)

Around 6.8 ppm: attributed to a benzene ring of bisphenol A (corresponding to 4 hydrogen atoms) and attributed to a double bond of a fumaric acid (corresponding to 2 hydrogen atoms)

Around from 5.2 ppm to 5.4 ppm: attributed to methine of a bisphenol A propylene oxide adduct (corresponding to 1 hydrogen atom)

Around from 4.0 ppm to 5.0 ppm: attributed to methylene of an aliphatic alcohol (corresponding to 2 hydrogen atoms)

Around from 3.7 ppm to 4.7 ppm: attributed to methylene of a bisphenol A propylene oxide adduct (corresponding to 2 hydrogen atoms) and attributed to methylene of a bisphenol A ethylene oxide adduct (corresponding to 4 hydrogen atoms)

Around from 2.2 ppm to 2.6 ppm: attributed to methylene of an aliphatic dicarboxylic acid (corresponding to 2 hydrogen atoms)

From 1.6 ppm: attributed to a methyl group of bisphenol A and an aliphatic alcohol (corresponding to 6 hydrogen atoms)

From these results, for example, the extract collected in a fraction in which the polyester resin accounts for 90% or higher can be processed as the polyester resin.

Likewise, the extract collected in a fraction in which the any other polyester resin accounts for 90% or higher can be processed as the any other polyester resin.

The extract collected in a fraction in which the crystalline polyester resin accounts for 90% or higher can be processed as the crystalline polyester resin.

### <<Method for Measuring Melting Point and Glass Transition Temperature (Tg)>>

In the present invention, the melting point and the glass transition temperature (Tg) can be measured with, for example, a DSC system (a differential scanning calorimeter) (“Q-200” available from TA Instruments Inc.).

Specifically, the melting point and the glass transition temperature of a target sample can be measured according to the procedure described below.

First, about 5.0 mg of the target sample is put in a sample container made of aluminium, and the sample container is put on a holder unit and set in an electric furnace. Next, the target sample is heated under a nitrogen atmosphere from −80° C. to 150° C. at a temperature raising rate of 10° C./min (first temperature raise). After this, the target sample is cooled from 150° C. to −80° C. at a temperature dropping rate of 10° C./min, and again heated to 150° C. at a temperature raising rate of 10° C./min (second temperature raise). For each of the first temperature raise and the second temperature raise, a DSC curve is measured with the differential scanning calorimeter (“Q-200” available from TA Instruments Inc.).

With an analyzing program in the Q-200 system, the DSC curve of the first temperature raise can be selected from the obtained DSC curves, and the glass transition temperature of the target sample at the first temperature raise can be obtained. Likewise, the DSC curve of the second temperature raise can be selected, and the glass transition temperature of the target sample at the second temperature raise can be obtained.

Further, with the analyzing program in the Q-200 system, the DSC curve of the first temperature raise can be selected from the obtained DSC curves, and an endothermic peak top temperature of the target sample at the first temperature raise can be obtained as a melting point. Likewise, the DSC curve of the second temperature raise can be selected, and an endothermic peak top temperature of the target sample at the second temperature raise can be obtained as a melting point.

In the present specification, the glass transition temperature at the first temperature raise and the glass transition temperature at the second temperature raise when the toner is used as the target sample are referred to as Tg1st and Tg2nd respectively.

Further, in the present specification, the glass transition temperature and the melting point of the polyester resin, the crystalline polyester resin, and the other constituent components such as the release agent refer to the endothermic peak top temperature and Tg of the respective target samples at the second temperature raise, unless otherwise specified.

### <Method for Producing Toner>

A method for producing the toner is not particularly limited, and an arbitrary method may be selected according to the purpose. However, it is preferable to granulate the toner by dispersing in an aqueous medium, an oil phase containing the polyester resin, preferably further containing the crystalline polyester resin, and further containing the release agent, the colorant, etc. as needed.

It is more preferable to granulate the toner by dispersing in an aqueous medium, an oil phase containing as the polyester resin, the polyester resin that is the prepolymer having a urethane bond and a urea bond and the any other polyester resin free of a urethane bond and a urea bond, preferably containing the crystalline polyester resin, and further containing the release agent, the colorant, etc. as needed.

Examples of such a toner producing method include a publicly-known dissolution suspension method. As an example of the toner producing method, a method for forming toner base particles while elongating the polyester resin by an elongation reaction, a cross-linking reaction, or both of the prepolymer with water will be described below. This method involves preparation of an aqueous medium, preparation of an oil phase containing the toner materials, emulsification or dispersion of the toner materials, and removal of an organic solvent.

### —Preparation of Aqueous Medium (Aqueous Phase)—

An aqueous medium can be prepared by, for example, dispersing resin particles in an aqueous medium. An additive amount of the resin particles in the aqueous medium is not particularly limited, and may be appropriately selected according to the purpose. However, the additive amount is preferably from 0.5 parts by mass to 10 parts by mass relative to 100 parts by mass of the aqueous medium.

The aqueous medium is not particularly limited, and an arbitrary aqueous medium may be selected according to the purpose. Examples of the aqueous medium include water, a solvent miscible with water, and a mixture thereof. One of these may be used alone, or two or more of these may be used in combination. Among these, water is preferable.

The solvent miscible with water is not particularly limited, and an arbitrary solvent may be selected according to the purpose. Examples of the solvent include alcohols, dimethylformamide, tetrahydrofuran, cellosolves, and lower ketones. The alcohols are not particularly limited, and an arbitrary alcohol may be selected according to the purpose. Examples of the alcohols include methanol, isopropanol, and ethylene glycol. The lower ketones are not particularly limited, and an arbitrary lower ketone may be selected according to the purpose. Examples of the lower ketones include acetone and methyl ethyl ketone.

### —Preparation of Oil Phase—

The oil phase containing the toner materials can be prepared by dissolving or dispersing in an organic solvent, the toner materials including: the polyester resin that is the prepolymer having a urethane bond and a urea bond and produced from a reaction between an active hydrogen group of a polyester resin and a polyisocyanate; and the any other polyester resin free of a urethane bond and a urea bond, preferably including the crystalline polyester resin, and further including the release agent, the colorant, etc. as needed.

The organic solvent is not particularly limited, and an arbitrary organic solvent may be selected according to the purpose. However, an organic solvent having a boiling point of lower than 150° C. is preferable because such an organic solvent is easy to remove.

The organic solvent having a boiling point of lower than 150° C. is not particularly limited, and an arbitrary organic solvent may be selected according to the purpose. Examples of such organic solvents include toluene, xylene, benzene, carbon tetrachloride, methylene chloride, 1,2-dichloroethane, 1,1,2-trichloroethane, trichloroethylene, chloroform, monochlorobenzene, dichloroethylidene, methyl acetate, ethyl acetate, methyl ethyl ketone, and methyl isobutyl ketone. One of these may be used alone, or two or more of these may be used in combination.

Among these, ethyl acetate, toluene, xylene, benzene, methylene chloride, 1,2-dichloroethane, chloroform, carbon tetrachloride, etc. are preferable, and ethyl acetate is more preferable.

### —Emulsification or Dispersion—

The toner materials can be emulsified or dispersed by dispersing the oil phase containing the toner materials in the aqueous medium. An elongation reaction, a cross-linking reaction, or both of the prepolymer is induced by emulsifying or dispersing the toner materials and reacting the prepolymer with water.

Reaction conditions (a reaction time and a reaction temperature) for producing the prepolymer are not particularly limited.

The reaction time is not particularly limited, and may be appropriately selected according to the purpose. However, the reaction time is preferably from 10 minutes to 40 hours, and more preferably from 2 hours to 24 hours.

The reaction temperature is not particularly limited, and may be appropriately selected according to the purpose. However, the reaction temperature is preferably from 0° to 150° C., and more preferably from 40° C. to 98° C.

A method for forming a dispersion liquid containing the prepolymer stably in the aqueous medium is not particularly limited, and an arbitrary method may be selected according to the purpose. Examples of the method include a method for adding the oil phase prepared by dissolving or dispersing the toner materials in the organic solvent to the aqueous medium phase, and dispersing the oil phase under a shearing force.

A disperser for the dispersion is not particularly limited, and an arbitrary disperser may be selected according to the purpose. Examples of the disperser include a low-speed shearing disperser, a high-speed shearing disperser, a frictional disperser, a high-pressure jet disperser, and an ultrasonic disperser.

Among these, a high-speed shearing disperser is preferable because the particle diameter of the dispersion element (oil droplets) can be controlled to a range of from 2 μm to 20 μm.

In use of the high-speed shearing disperser, conditions such as a rotation speed, a dispersing time, a dispersing temperature, etc. may be appropriately selected according to the purpose.

The rotation speed is not particularly limited, and may be appropriately selected according to the purpose. However, the rotation speed is preferably from 1,000 rpm to 30,000 rpm, and more preferably from 5,000 rpm to 20,000 rpm.

The dispersing time is not particularly limited, and may be appropriately selected according to the purpose. However, the dispersing time is preferably from 0.1 minutes to 5 minute when the disperser is a batch system.

The dispersing temperature is not particularly limited, and may be appropriately selected according to the purpose. However, it is preferably from 0° C. to 150° C., and more preferably from 40° C. to 98° C. under pressure. Generally, dispersing is smooth at a high dispersing temperature.

An amount of the aqueous medium used for emulsifying or dispersing the toner materials is not particularly limited, and may be appropriately selected according to the purpose. However, the amount of use is preferably from 50 parts by mass to 2,000 parts by mass, and more preferably from 100 parts by mass to 1,000 parts by mass relative to 100 parts by mass of the toner materials.

When the amount of the aqueous medium used is 50 parts by mass or greater, the toner materials can be dispersed well, and toner base particles having a desired particle diameter can be obtained. When the amount of use is 2,000 parts by mass or less, the production cost can be saved.

When emulsifying or dispersing the oil phase containing the toner materials, it is preferable to use a dispersant in order to stabilize the dispersion element such as oil droplets to a desired shape and make a granularity distribution sharp.

The dispersant is not particularly limited, and an arbitrary dispersant may be selected according to the purpose. Examples of the dispersant include a surfactant, a sparingly-water-soluble inorganic compound dispersant, and a polymeric protective colloid. One of these may be used alone, or two or more of these may be used in combination. Among these, a surfactant are preferable.

The surfactant is not particularly limited, and an arbitrary surfactant may be selected according to the purpose. Examples of the surfactant include an anionic surfactant, a cationic surfactant, a nonionic surfactant, and an amphoteric surfactant.

The anionic surfactant is not particularly limited, and an arbitrary anionic surfactant may be selected according to the purpose. Examples of the anionic surfactant include alkyl benzene sulfonate, α-olefin sulfonate, and phosphate ester. Among these, an anionic surfactant having a fluoroalkyl group is preferable.

### —Removal of Organic Solvent—

A method for removing the organic solvent from the dispersion liquid such as an emulsified slurry is not particularly limited, and an arbitrary method may be selected according to the purpose. Examples of the method include a method for gradually raising the temperature of the whole reaction system to evaporate the organic solvent in the oil droplets, and a method for spraying the dispersion liquid in a dry atmosphere to remove the organic solvent in the oil droplets.

After the removal of the organic solvent, the slurry is aged at an adjusted temperature for an adjusted time. After this, the resultant is washed and dried to form toner base particles.

The toner base particles may be classified. It is possible to perform the classification by removing minute particles by a cyclone, a decanter, centrifugation, etc. in a liquid, or to perform the classification after drying the toner base particles.

The obtained toner base particles may be mixed with particles of the external additive, the charge controlling agent, etc. For the mixing, it is possible to apply a mechanical impact to suppress the particles of the external additive, etc. from being detached from the surface of the toner base particles.

A method for applying the mechanical impact is not particularly limited, and an arbitrary method may be selected according to the purpose. Examples of the method include a method for applying an impact to the mixture with a blade rotating at a high speed, and a method for feeding the mixture to a high-speed air current to accelerate the mixture and make the particles collide against the particles or against a board appropriate for collision.

An apparatus used for the method is not particularly limited, and an arbitrary apparatus may be selected according to the purpose. Examples of the apparatus include an angmill (available from Hosokawa Micron Corp.), an apparatus obtained by remodeling an I-type mill (available from Nippon Pneumatic Mfg. Co., Ltd.) to have a lower pulverizing air pressure, a hybridization system (available from Nara Machinery Co., Ltd.), KRIPTRON SYSTEM (available from Kawasaki Heavy Industries, Ltd.), and an automatic mortar.

### (Developer)

A developer of the present invention contains at least the toner, and appropriately selected other components such as a carrier as needed.

Hence, the developer is excellent in transferability, chargeability, etc., and can form high-quality images stably. The developer may be a one-component developer or a two-component developer. However, for use in a high-speed printer or the like that accommodates the recent improvement in the information processing speed, a two-component developer is preferable in terms of a longer life span.

### <Carrier>

The carrier is not particularly limited, and an arbitrary carrier may be selected according to the purpose. A preferable carrier contains a core material and a resin layer coating the core material.

### (Image Forming Apparatus and Image Forming Method)

An image forming apparatus of the present invention includes at least an electrostatic latent image bearer, an electrostatic latent image forming unit, and a developing unit, and further includes other units as needed.

An image forming method of the present invention includes at least an electrostatic latent image forming step and a developing step, and further includes other steps as needed.

The image forming method can be performed favorably by the image forming apparatus. The electrostatic latent image forming step can be performed favorably by the electrostatic latent image forming unit. The developing step can be performed favorably by the developing unit. The other steps can be performed favorably by the other units.

### <Electrostatic Latent Image Bearer>

The electrostatic latent image bearer is not particularly limited and may be of any material, any form, and any size. An arbitrary electrostatic latent image bearer may be selected from known ones. In terms of material, examples of the electrostatic latent image bearer include inorganic photoconductors made of amorphous silicon, selenium, etc., and organic photoconductors made of polysilane, phthalopolymethine, etc.

### <Electrostatic Latent Image Forming Unit>

The electrostatic latent image forming unit is not particularly limited, and an arbitrary electrostatic latent image forming unit may be selected according to the purpose so long as such an electrostatic latent image forming unit is a unit configured to form an electrostatic latent image over the electrostatic latent image bearer. Examples of the electrostatic latent image forming unit include a unit including a charging member configured to electrically charge the surface of the electrostatic latent image bearer and an exposing member configured to expose the surface of the electrostatic latent image bearer to light imagewise.

### <Developing Unit>

The developing unit is not particularly limited, and an arbitrary developing unit may be selected according to the purpose so long as such a developing unit contains a toner and is configured to develop the electrostatic latent image formed over the electrostatic latent image bearer to form a visible image.

### <Other Units>

Examples of the other units include a transfer unit, a fixing unit, a cleaning unit, a charge removing unit, a recycling unit, and a controlling unit.

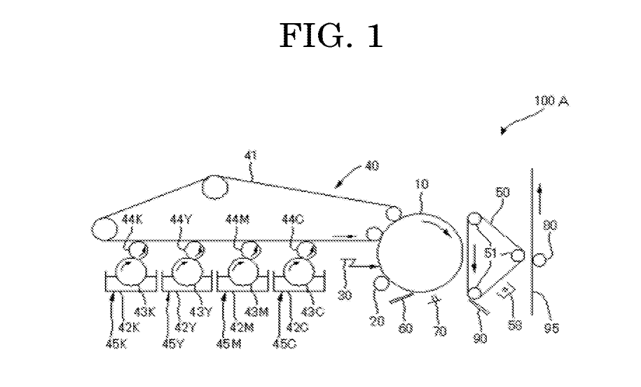

Next, one mode of a method for forming an image with the image forming apparatus of the present invention will be described with reference to FIG. 1. A color image forming apparatus 100A illustrated in FIG. 1 includes a photoconductor drum 10 (may be referred to as “photoconductor 10” hereinafter) as the electrostatic latent image bearer, a charging roller 20 as the charging member, an exposing device 30 as the exposing member, a developing device 40 as the developing unit, an intermediate transfer member 50, a cleaning device 60 as the cleaning unit including a cleaning blade, and a charge removing lamp 70 as the charge removing unit.

The intermediate transfer member 50 is an endless belt, and designed to be movable in the direction represented by the arrow by three rollers 51 disposed inside the loop of the endless belt and applying a tension to the endless belt. Some of the three rollers 51 also function as a transfer bias roller capable of applying a predetermined transfer bias (first transfer bias) to the intermediate transfer member 50. A cleaning device 90 including a cleaning blade is disposed near the intermediate transfer member 50. A transfer roller 80 as the transfer unit capable of applying a transfer bias for transferring (secondly transferring) a developed image (toner image) onto a transfer sheet 95 as a recording medium is disposed near the intermediate transfer member 50 to face the intermediate transfer member 50. A corona charger 58 configured to impart charges to the toner image over the intermediate transfer member 50 is disposed on the circumference of the intermediate transfer member 50 at a middle portion between where the photoconductor 10 contacts the intermediate transfer member 50 and where the intermediate transfer member 50 contacts the transfer sheet 95 in the direction of rotation of the intermediate transfer member 50.

The developing device 40 includes a developing belt 41 as a developer bearer, and a black developing unit 45K, a yellow developing unit 45Y, a magenta developing unit 45M, and a cyan developing unit 45C arranged side by side on the circumference of the developing belt 41. The black developing unit 45K includes a developer container 42K, a developer supplying roller 43K, and a developing roller 44K. The yellow developing unit 45Y includes a developer container 42Y, a developer supplying roller 43Y, and a developing roller 44Y. The magenta developing unit 45M includes a developer container 42M, a developer supplying roller 43M, and a developing roller 44M. The cyan developing unit 45C includes a developer container 42C, a developer supplying roller 43C, and a developing roller 44C. The developing belt 41 is an endless belt, is tensed by a plurality of belt rollers in a rotatable manner, and partially contacts the electrostatic latent image bearer 10.

In the color image forming apparatus 100 illustrated in FIG. 1, for example, the charging roller 20 electrically charges the photoconductor drum 10 uniformly. The exposing device 30 exposes the photoconductor drum 10 to light imagewise to form an electrostatic latent image. The developing device 40 supplies a toner and develops the electrostatic latent image formed over the photoconductor drum 10 to form a toner image. The toner image is transferred (firstly transferred) onto the intermediate transfer member 50 upon a voltage applied by the rollers 51, and further transferred (secondly transferred) onto the transfer sheet 95. As a result, a transferred image is formed over the transfer sheet 95. A residual toner over the photoconductor 10 is removed by the cleaning device 60, and charges over the photoconductor 10 are once removed by the charge removing lamp 70.

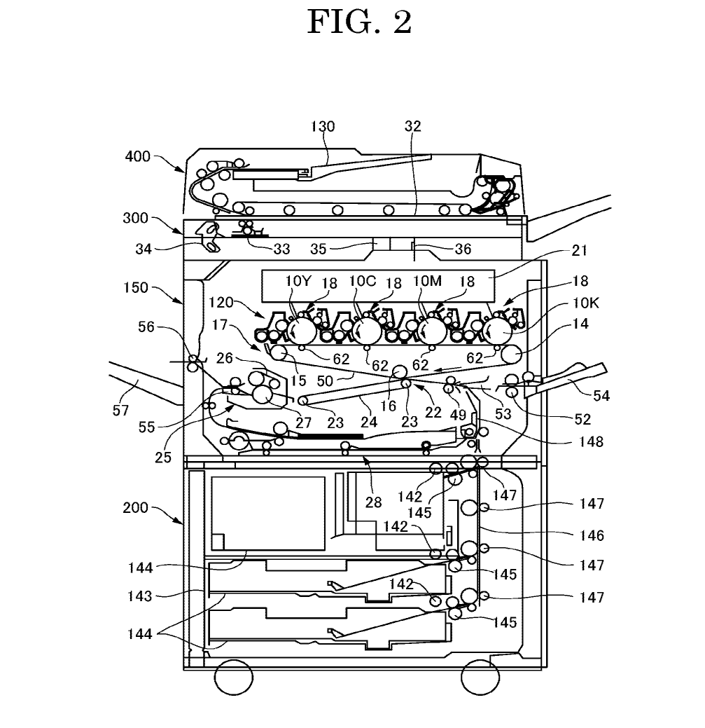

FIG. 2 illustrates another example of the image forming apparatus of the present invention. The image forming apparatus illustrated in FIG. 2 includes a copier body 150, a paper feeding table 200, a scanner 300, and an automatic document feeder (ADF) 400.

The copier body 150 includes an endless belt type intermediate transfer member 50 in the center. The intermediate transfer member 50 is tensed over supporting rollers 14, 15, and 16, and rotatable in the clockwise direction of FIG. 2. An intermediate transfer member cleaning device 17 configured to remove a residual toner over the intermediate transfer member 50 is disposed near the supporting roller 15. A tandem developing device 120 including four image forming units 18 for yellow, cyan, magenta, and black disposed side by side along the direction in which the intermediate transfer member 50 is conveyed is provided for the intermediate transfer member 50 tensed by the supporting roller 14 and the supporting roller 15. An exposing device 21 as the exposing member is disposed near the tandem developing device 120. A second transfer device 22 is disposed at a side of the intermediate transfer member 50 opposite to a side where the tandem developing device 120 is disposed. In the second transfer device 22, a second transfer belt 24 which is an endless belt is tensed by a pair of rollers 23, and a transfer sheet conveyed over the second transfer belt 24 and the intermediate transfer member 50 can contact each other. A fixing device 25 as the fixing unit is disposed near the second transfer device 22. The fixing device 25 includes a fixing belt 26 which is an endless belt, and a pressure roller 27 disposed as pressed by the fixing belt 26.

The tandem image forming apparatus includes a sheet overturning device 28 disposed near the second transfer device 22 and the fixing device 25 and configured to overturn a transfer sheet to form images over both sides of the transfer sheet.

Next, full-color image formation (color copying) with the tandem developing device 120 will be described. First, a document is set over a document table 130 of the automatic document feeder (ADF) 400. Alternatively, the automatic document feeder 400 is opened, the document is set over a contact glass 32 of the scanner 300, and the automatic document feeder 400 is closed.

Upon depression of a start switch (unillustrated), the scanner 300 is actuated after the document is conveyed and moved to over the contact glass 32, or is actuated immediately after the depression when the document is set over the contact glass 32. Then, a first running member 33 and a second running member 34 are started to travel. At the time, the first running member 33 irradiates the document with light from a light source, and light reflected from the document surface is reflected by a mirror of the second running member 34 and received by a reading sensor 36 through an imaging forming lens 35. In this way, the color document (color image) is read as image information for black, yellow, magenta, and cyan.

The respective pieces of image information for black, yellow, magenta, and cyan are transmitted to the respective image forming units 18 (i.e., the black image forming unit, the yellow image forming unit, the magenta image forming unit, and the cyan image forming unit) in the tandem developing device 120. Then, the respective image forming units form toner images of black, yellow, magenta, and cyan, respectively. That is, the respective image forming units 18 (i.e., the black image forming unit, the yellow image forming unit, the magenta image forming unit, and the cyan image forming unit) in the tandem developing device 120 each include an electrostatic latent image bearer 10 (i.e., a black electrostatic latent image bearer 10K, a yellow electrostatic latent image bearer 10Y, a magenta electrostatic latent image bearer 10M, and a cyan electrostatic latent image bearer 10C), a charging device 160 as the charging member configured to electrically charge the electrostatic latent image bearer 10 uniformly, an exposing device configured to expose the electrostatic latent image bearer to light imagewise like an image corresponding to each color image based on each color image formation to form an electrostatic latent image corresponding to the color image over the electrostatic latent image bearer, a developing device 61 as the developing unit configured to develop the electrostatic latent image with each color toner (i.e., a black toner, a yellow toner, a magenta toner, and a cyan toner) to form a toner image of each color toner, a transfer charging device 62 configured to transfer the toner image onto the intermediate transfer member 50, a cleaning device 63, and a charge removing device 64. The respective image forming units 18 can each form a single-color image of each color (i.e., a black image, a yellow image, a magenta image, and a cyan image) based on the image information of each color. The black image, the yellow image, the magenta image, and the cyan image formed in this way over the black electrostatic latent image bearer 10K, the yellow electrostatic latent image bearer 10Y, the magenta electrostatic latent image bearer 10M, and the cyan electrostatic latent image bearer 10C, respectively, are transferred (firstly transferred) sequentially onto the intermediate transfer member 50 that is being rotated and moved by the supporting rollers 14, 15, and 16. Then, the black image, the yellow image, the magenta image, and the cyan image are overlaid together over the intermediate transfer member 50 to form a composite color image (color transferred image).

Meanwhile, in the paper feeding table 200, one of paper feeding rollers 142 is selectively rotated to bring forward sheets (recording sheets) from one of paper feeding cassettes 144 provided multi-stage in a paper bank 143. The sheets are sent forth to a paper feeding path 146 one by one separately via a separating roller 145, conveyed and guided to a paper feeding path 148 in the copier body 150 by a conveying roller 147, and stopped upon collision on a registration roller 49. Alternatively, the paper feeding rollers 142 are rotated to bring forward sheets (recording sheets) placed over a manual feed tray 54 and let the sheets into a manual paper feeding path 53 one by one separately via a separating roller 52, and the sheets are likewise stopped upon collision on the registration roller 49. The registration roller 49 is commonly used in an earthed state, but may be used in a bias-applied state for removal of sheet dusts from the sheets. In pace with the composite color image (color transferred image) combined over the intermediate transfer member 50, the registration roller 49 is rotated to send forth a sheet (recording sheet) to between the intermediate transfer member 50 and the second transfer device 22, which then transfers (secondly transfers) the composite color image (color transferred image) onto the sheet (recording sheet). In this way, a color image is transferred and formed over the sheet (recording sheet). A toner remaining over the intermediate transfer member 50 after the image transfer is cleaned by the intermediate transfer member cleaning device 17.

The sheet (recording sheet) over which the color image is transferred and formed is conveyed by the second transfer device 22 and delivered to the fixing device 25, which then fixes the composite color image (color transferred image) over the sheet (recording sheet) by heat and pressure. After this, the sheet (recording sheet) is switched at a switching claw 55 to be ejected by an ejecting roller 56 and stacked over a paper ejecting tray 57. Alternatively, the sheet is switched at the switching claw 55 to be overturned by the sheet overturning device 28 and again guided to the transfer position, and after having an image recorded on the back side, ejected by the ejecting roller 56 and stacked over the paper ejecting tray 57.

### EXAMPLES

Examples of the present invention will be described below. The present invention is not limited to the Examples below by any means. “Part” represents “part by mass” unless otherwise expressly specified. “%” represents “% by mass” unless otherwise expressly specified.

The measurement values in the Examples below were measured according to the method described herein. Tg and molecular weight of the polyester resin, the any other polyester resin, the crystalline polyester resin, etc. were measured from the resins obtained in Production Examples.

### Production Example A1

### Synthesis of Amorphous Polyester Resin A1

A terephthalic acid (26.5 parts), a bisphenol A ethylene oxide 2.2 mol adduct (13.5 parts), a bisphenol A propylene oxide 2.2 mol adduct (59.9 parts), and dibutyl tin oxide (0.2 parts) were put in a reaction tank including a cooling tube, a stirrer, and a nitrogen introducing tube, reacted at normal pressure at 230° C. for 4 hours, and then reacted at a reduced pressure of from 10 mmHg to 15 mmHg for 5 hours, to obtain an amorphous polyester resin A1.

### Production Example A2

### Synthesis of Amorphous Polyester Resin A2

An isophthalic acid (22.4 parts), a bisphenol A ethylene oxide 2.2 mol adduct (56.9 parts), a bisphenol A propylene oxide 2.2 mol adduct (15.8 parts), and dibutyl tin oxide (0.2 parts) were put in a reaction tank including a cooling tube, a stirrer, and a nitrogen introducing tube, reacted at normal pressure at 230° C. for 4 hours, and then reacted at a reduced pressure of from 10 mmHg to 15 mmHg for 5 hours, to obtain an amorphous polyester resin A2.

### Production Example pA1

### Synthesis of Amorphous Polyester Resin pA1

A terephthalic acid (25.8 parts), an adipic acid (27.8 parts), 3-methyl-1,5-pentanediol (44.9 parts), trimethylol propane (1.5 parts), and dibutyl tin oxide (0.2 parts) were put in a reaction tank including a cooling tube, a stirrer, and a nitrogen introducing tube, reacted at normal pressure at 230° C. for 4 hours, and then reacted at a reduced pressure of from 10 mmHg to 15 mmHg for 5 hours, to obtain an intermediate product of an amorphous polyester resin pA1.

Next, the intermediate product of the amorphous polyester resin pA1 (90 parts) and isophorone diisocyanate (IPDI) (10 parts) were put in a reaction container including a cooling tube, a stirrer, and a nitrogen introducing tube, diluted with ethyl acetate (100 parts), and then reacted at 80° C. for 5 hours, to obtain [ethyl acetate solution of amorphous polyester resin pA1] that was a prepolymer.

### Production Examples pA2 to pA8

### Synthesis of Amorphous Polyester Resins pA2 to pA8

Ethyl acetate solutions of amorphous polyester resins pA2 to pA8 that were prepolymers were obtained in the same manner as in Production Example pA1, except that the kinds and blending amounts of the respective monomers used in Production Example pA1 were changed to the kinds and blending amounts presented in Table 1-1 and Table 1-2.

Table 1-1 and Table 1-2 present the kinds and blending amounts of the respective monomers. The unit is “part by mass”.

Table 1-3 and Table 1-4 present ratios by mole of respective dicarboxylic acids as the dicarboxylic acid component, and ratios by mole (%) of respective diols as the diol component.

Table 2 presents material blending ratios of the ethyl acetate solutions of amorphous polyester resins pA1 to pA8. The unit is “part by mass”.

TABLE 1-1

| | Amorphous polyester resin | | | | | |
|---|---|---|---|---|---|---|
| | | | pA1 | pA2 | pA3 | pA4 |
| | | | intermediate | intermediate | intermediate | intermediate |
| | A1 | A2 | product | product | product | product |
| Terephthalic acid | 26.5 | 0 | 25.8 | 25.8 | 25.5 | 27.3 |
| Isophthalic acid | 0 | 22.4 | 0 | 0 | 0 | 0 |
| Adipic acid | 0 | 4.9 | 27.8 | 27.8 | 27.4 | 29.3 |
| Bisphenol A ethylene oxide | 13.5 | 56.9 | 0 | 0 | 0 | 0 |
| 2.2 mol adduct | | | | | | |
| Bisphenol A propylene | 56.9 | 15.8 | 0 | 0 | 0 | 0 |
| oxide 2.2 mol adduct | | | | | | |
| Ethylene glycol | 0 | 0 | 0 | 0 | 0 | 0 |
| Propylene glycol | 0 | 0 | 0 | 0 | 0 | 0 |
| 1,4-butanediol | 0 | 0 | 0 | 0 | 0 | 0 |
| 1,5-pentanediol | 0 | 0 | 0 | 0 | 0 | 41.8 |
| 2-methyl-1,3-propanediol | 0 | 0 | 0 | 0 | 0 | 0 |
| 3-methyl-1,5-pentanediol | 0 | 0 | 44.9 | 44.9 | 44.3 | 0 |
| 1,12-dodecanediol | 0 | 0 | 0 | 0 | 0 | 0 |
| Trimethylolpropane | 0 | 0 | 1.5 | 0 | 0 | 1.6 |
| Pentaerythritol | 0 | 0 | 0 | 1.6 | 0 | 0 |
| Dipentaerythritol | 0 | 0 | 0 | 0 | 2.9 | 0 |
| Trimellitic acid | 0 | 0 | 0 | 0 | 0 | 0 |
| Dibutyl tin oxide | 0.2 | 0.2 | 0.2 | 0.2 | 0.2 | 0.2 |

TABLE 1-2

| | Amorphous polyester resin | | | |
|---|---|---|---|---|
| | | pA6 | pA7 | pA8 |
| | pA5 | inter- | inter- | inter- |
| | intermediate | mediate | mediate | mediate |
| | product | product | product | product |
| Terephthalic acid | 28.9 | 28.9 | 34.1 | 39.5 |
| Isophthalic acid | 0 | 0 | 0 | 0 |
| Adipic acid | 31.1 | 31.1 | 20.0 | 14.9 |
| Bisphenol A ethylene oxide | 0 | 0 | 0 | 0 |
| 2.2 mol adduct | | | | |
| Bisphenol A propylene | 0 | 0 | 0 | 0 |
| oxide 2.2 mol adduct | | | | |
| Ethylene glycol | 0 | 0 | 0 | 0 |
| Propylene glycol | 0 | 0 | 0 | 0 |
| 1,4-butanediol | 38.3 | 0 | 0 | 0 |
| 1,5-pentanediol | 0 | 0 | 0 | 0 |
| 2-methyl-1,3-propanediol | 0 | 38.3 | 0 | 0 |
| 3-methyl-1,5-pentanediol | 0 | 0 | 44.4 | 44.1 |
| 1,12-dodecanediol | 0 | 0 | 0 | 0 |
| Trimethylolpropane | 1.7 | 1.7 | 1.5 | 1.5 |
| Pentaerythritol | 0 | 0 | 0 | 0 |
| Dipentaerythritol | 0 | 0 | 0 | 0 |
| Trimellitic acid | 0 | 0 | 0 | 0 |
| Dibutyl tin oxide | 0.2 | 0.2 | 0.2 | 0.2 |

TABLE 1-3

| | | Amorphous polyester resin | | | | | |
|---|---|---|---|---|---|---|---|
| | | A1 | A2 | pA1 | pA2 | pA3 | pA4 |
| Dicarboxylic | Terephthalic acid | 100 | 0 | 45 | 45 | 45 | 45 |
| acid | Isophthalic acid | 0 | 80 | 0 | 0 | 0 | 0 |
| | Adipic acid | 0 | 20 | 55 | 55 | 55 | 55 |
| Diol | Bisphenol A ethylene oxide 2.2 | 20 | 80 | 0 | 0 | 0 | 0 |
| | mol adduct | | | | | | |
| | Bisphenol A propylene oxide | 80 | 20 | 0 | 0 | 0 | 0 |
| | 2.2 mol adduct | | | | | | |
| | Ethylene glycol | 0 | 0 | 0 | 0 | 0 | 0 |
| | Propylene glycol | 0 | 0 | 0 | 0 | 0 | 0 |
| | 1,4-butanediol | 0 | 0 | 0 | 0 | 0 | 0 |
| | 1,5-pentanediol | 0 | 0 | 0 | 0 | 0 | 100 |
| | 2-methyl-1,3-propanediol | 0 | 0 | 0 | 0 | 0 | 0 |
| | 3-methyl-1,5-pentanediol | 0 | 0 | 100 | 100 | 100 | 0 |
| | 1,12-dodecanediol | 0 | 0 | 0 | 0 | 0 | 0 |

TABLE 1-4

| | | Amorphous polyester resin | | | |
|---|---|---|---|---|---|
| | | pA5 | pA6 | pA7 | pA8 |
| Dicarboxylic | Terephthalic acid | 45 | 45 | 60 | 70 |
| acid | Isophthalic acid | 0 | 0 | 0 | 0 |
| | Adipic acid | 55 | 55 | 40 | 30 |
| Diol | Bisphenol A ethylene oxide | 0 | 0 | 0 | 0 |
| | 2.2 mol adduct | | | | |
| | Bisphenol A propylene oxide | 0 | 0 | 0 | 0 |
| | 2.2 mol adduct | | | | |
| | Ethylene glycol | 0 | 0 | 0 | 0 |
| | Propylene glycol | 0 | 0 | 0 | 0 |
| | 1,4-butanediol | 100 | 0 | 0 | 0 |
| | 1,5-pentanediol | 0 | 0 | 0 | 0 |
| | 2-methyl-1,3-propanediol | 0 | 100 | 0 | 0 |
| | 3-methyl-1,5-pentanediol | 0 | 0 | 100 | 100 |
| | 1,12-dodecanediol | 0 | 0 | 0 | 0 |

TABLE 2

| | Amorphous polyester resin (prepolymer) | | | | | | | |
|---|---|---|---|---|---|---|---|---|
| | pA1 | pA2 | pA3 | pA4 | pA5 | pA6 | pA7 | pA8 |
| pA1 intermediate product | 90 | 0 | 0 | 0 | 0 | 0 | 0 | 0 |
| pA2 intermediate product | 0 | 90 | 0 | 0 | 0 | 0 | 0 | 0 |
| pA3 intermediate product | 0 | 0 | 90 | 0 | 0 | 0 | 0 | 0 |
| pA4 intermediate product | 0 | 0 | 0 | 90 | 0 | 0 | 0 | 0 |
| pA5 intermediate product | 0 | 0 | 0 | 0 | 90 | 0 | 0 | 0 |
| pA6 intermediate product | 0 | 0 | 0 | 0 | 0 | 90 | 0 | 0 |
| pA7 intermediate product | 0 | 0 | 0 | 0 | 0 | 0 | 90 | 0 |
| pA8 intermediate product | 0 | 0 | 0 | 0 | 0 | 0 | 0 | 90 |
| IPDI | 10 | 10 | 10 | 10 | 10 | 10 | 10 | 10 |
| Ethyl acetate | 100 | 100 | 100 | 100 | 100 | 100 | 100 | 100 |

### <Synthesis of Crystalline Polyester Resin B>

A dodecanedioic acid and 1,6-hexanediol were put in a 5 L four-necked flask including a nitrogen introducing tube, a dehydrating tube, a stirrer, and a thermocouple such that OH/COOH, which was a ratio by mole of hydroxyl group to carboxyl group, would be 0.9, reacted in the presence of titanium tetraisopropoxide (500 ppm relative to the resin components) at 180° C. for 10 hours, reacted at a raised temperature of 200° C. for 3 hours, and then further reacted under a pressure of 8.3 kPa for 2 hours, to obtain a crystalline polyester resin B.

### Example 1

### Preparation of Master Batch (MB)

Water (1,200 parts), carbon black (PRINTEX 35 available from Degussa Co., Ltd.) [with DBP oil absorption=42 mL/100 mg and pH=9.5] (500 parts), and the amorphous polyester resin A1 (500 parts) were mixed with a Henschel mixer (available from Nippon Coke & Engineering Co., Ltd.). The mixture was kneaded with two rolls at 150° C. for 30 minutes, rolled and cooled, and then pulverized with a pulverizer, to obtain [master batch 1].

### <Production of Wax Dispersion Liquid>

A paraffin wax (50 parts) as a release agent (HNP-9 available from Nippon Seiro Co., Ltd., a hydrocarbon-based wax with a melting point of 75° C. and SP value of 8.8) and ethyl acetate (450 parts) were put in a container equipped with a stirring bar and a thermometer, heated to 80° C. while being stirred, retained at 80° C. for 5 hours, cooled to 30° C. in 1 hour, and then dispersed with a bead mill (ULTRA VISCO MILL available from Aimex Co., Ltd.) at a liquid sending speed of 1 kg/hr, at a disk peripheral velocity of 6 m/second, with zirconia beads having a diameter of 0.5 mm packed to 80% by volume, and for 3 passes, to obtain [wax dispersion liquid].

### <Production of Crystalline Polyester Resin Dispersion Liquid>

The crystalline polyester resin B (50 parts) and ethyl acetate (450 parts) were put in a container equipped with a stirring bar and a thermometer, heated to 80° C. while being stirred, retained at 80° C. for 5 hours, cooled to 30° C. in 1 hour, and then dispersed with a bead mill (ULTRA VISCO MILL available from Aimex Co., Ltd.) at a liquid sending speed of 1 kg/hr, at a disk peripheral velocity of 6 m/second, with zirconia beads having a diameter of 0.5 mm packed to 80% by volume, and for 3 passes, to obtain [crystalline polyester resin dispersion liquid].

### <Preparation of Oil Phase>

[Wax dispersion liquid] (500 parts), [ethyl acetate solution of amorphous polyester resin pA1] (300 parts), [crystalline polyester resin dispersion liquid] (500 parts), [amorphous polyester resin A1] (700 parts), and [master batch 1] (100 parts) were put in a container, and mixed with a TK homomixer (available from Primix Corporation) at 5,000 rpm for 60 minutes, to obtain [oil phase].

### <Synthesis of Organic Particle Emulsion (Particle Dispersion Liquid)>

Water (683 parts), sodium salt of methacrylic acid ethylene oxide adduct sulfate ester (ELEMINOL RS-30 available from Sanyo Chemical Industries, Ltd.) (11 parts), styrene (138 parts), methacrylic acid (138 parts), and ammonium persulfate (1 part) were put in a reaction container equipped with a stirring bar and a thermometer and stirred at 400 rpm for 15 minutes, to obtain a white emulsion. The white emulsion was heated until the temperature in the system became 75° C., and reacted for 5 hours. A 1% ammonium persulfate aqueous solution (30 parts) was further added to the resultant, which was then aged at 75° C. for 5 hours to obtain [particle dispersion liquid], which was an aqueous dispersion liquid in which a vinyl-based resin (a copolymer of styrene-methacrylic acid-sodium salt of methacrylic acid ethylene oxide adduct sulfate ester) was dispersed.

A volume average particle diameter of [particle dispersion liquid] measured with LA-920 (available from Horiba, Ltd.) was 0.14 μm. Part of [particle dispersion liquid] was dried to isolate the resin moiety.

### <Preparation of Aqueous Phase>

Water (990 parts), [particle dispersion liquid] (83 parts), a 48.5% sodium dodecyl diphenyl ether disulfonate aqueous liquid (ELEMINOL MON-7 available from Sanyo Chemical Industries, Ltd.) (37 parts), and ethyl acetate (90 parts) were mixed and stirred, to obtain an opaque white liquid, which was used as [aqueous phase].

### <Emulsification/Desolventization>

[Aqueous phase] (1,200 parts) was added to a container in which [oil phase] (800 parts) was put, and [aqueous phase] and [oil phase] were mixed with a TK homomixer at a rotation speed of 13,000 rpm for 20 minutes, to obtain [emulsified slurry]. [Emulsified slurry] was put in a container equipped with a stirrer and a thermometer, desolventized at 30° C. for 8 hours, and then aged at 45° C. for 10 hours, to obtain [dispersed slurry].

### <Washing/Drying>

After [dispersed slurry] (100 parts) was filtered at a reduced pressure:

(1): Ion-exchanged water (100 parts) was added to the resulting filter cake, and the ion-exchanged water and the filter cake were mixed with a TK homomixer (at a rotation speed of 12,000 rpm for 10 minutes) and then filtered;

(2): A 10% sodium hydroxide aqueous solution (100 parts) was added to the filter cake of (1), and the 10% sodium hydroxide aqueous solution and the filter cake were mixed with a TK homomixer (at a rotation speed of 12,000 rpm for 30 minutes) and then filtered at a reduced pressure:

(3): A 10% hydrochloric acid (100 parts) was added to the filter cake of (2), and the 10% hydrochloric acid and the filter cake were mixed with a TK homomixer (at a rotation speed of 12,000 rpm for 10 minutes) and then filtered; and

(4): Ion-exchanged water (300 parts) was added to the filter cake of (3), and the ion-exchanged water and the filter cake were mixed with a TK homomixer (at a rotation speed of 12,000 rpm for 10 minutes).

The operations (1) to (4) described above were repeated twice, to obtain [filter cake].

[Filter cake] was dried with an air circulating dryer at 45° C. for 48 hours and sieved through a mesh having a mesh size of 75 μm, to obtain [toner base particles 1].

### <Externally Adding Treatment>

The toner base particles 1 (100 parts by mass), hydrophobic silica having an average particle diameter of 100 nm (0.6 parts by mass), titanium oxide having an average particle diameter of 20 nm (1.0 part by mass), and hydrophobic silica particles having an average particle diameter of 15 nm (0.8 parts) were mixed with a Henschel mixer, to obtain a toner 1.

Table 3 presents the blending ratio and aging time of the toner of Example 1. A ratio (B)/(A) between a nitrogen content (A) in a compound contained in a pyrolysate of the toner and having two isocyanate groups and a nitrogen content (B) in a compound contained in the pyrolysate of the toner and having one isocyanate group and one amino group, and a nitrogen content in the surface of the toner were measured. Table 3 presents the results of the measurement.

### <Production of Carrier>

Toluene (100 parts by mass), a silicone resin (organo straight silicone) (100 parts by mass), γ-(2-aminoethyl)aminopropyl trimethoxy silane (5 parts by mass), and carbon black (10 parts by mass) were added together and dispersed with a homomixer for 20 minutes, to prepare a resin layer coating liquid. The resin layer coating liquid was applied to the surface of spherical magnetite having an average particle diameter of 50 μm (1,000 parts by mass), to produce a carrier.

### <Production of Developer>

The toner (5 parts by mass) and the carrier (95 parts by mass) were mixed with a ball mill, to produce a developer.

With the produced developer, various properties were evaluated in the manners described below. Table 4 and Table 5 present the results.

### <Offset Resistance>

With a unit of IMAGEO MP C4300 (available from Ricoh Company, Ltd.) charged with the developer, a rectangular solid image having a size of 2 cm×15 cm was formed over A4-size, long-grain PPC sheets TYPE 6000 <70W> (available from Ricoh Company, Ltd.) with an amount of toner accumulation of 0.40 mg/cm². The surface temperature of the fixing roller was varied to observe whether there would occur an offset of a residual developed image of the solid image being fixed at any place that was not desired and evaluate offset resistance.

### [Criteria for Evaluating Cold Offset]

A: Lower than 110° C.

B: 110° C. or higher but lower than 120° C.

C: 120° C. or higher but lower than 130° C.

D: 130° C. or higher

### [Criteria for Evaluating Hot Offset]

A: 170° C. or higher

B: 160° C. or higher but lower than 170° C.

C: 150° C. or higher but lower than 160° C.

D: Lower than 150° C.

### <Heat Resistant Storage Stability>

The toner was filled in a 50 mL glass container, left in a thermostat bath of 50° C. for 24 hours, and then cooled to 24° C. Next, penetration [mm] of the toner was measured according to a penetration test (JISK2235-1991) to evaluate heat resistant storage stability.

### [Evaluation Criteria]

A: Penetration was 20 mm or greater.

B: Penetration was 15 mm or greater but less than 20 mm.

C: Penetration was 10 mm or greater but less than 15 mm.

D: Penetration was less than 10 mm.

### <Chargeability: Amount of Static Buildup (−μC/g)>

The two-component developer was weighed out in an amount of 6 g, put in a sealable metallic cylinder, and stirred at a stirring speed of 280 rpm. Then, the amount of static buildup (−μC/g) in the developer was measured according to a blow-off method. The measurement was performed under stirring time conditions of 15 seconds (TA15), 60 seconds (TA60), and 600 seconds (TA600).

Favorable results in TA60 and TA600 mean a favorable charging stability. A favorable result in TA15 means a favorable charging response.

### [Evaluation Criteria]

A: 36 or greater

B: 33 or greater but less than 36

C: 30 or greater but less than 33

D: Less than 30

### Example 2

A toner of Example 2 was obtained in the same manner as in Example 1, except that the aging time in <Emulsification/Desolventization> of Example 1 was changed to 5 hours.

A (B)/(A) value in the pyrolysate of the toner and a nitrogen content in the surface of the toner were measured and various properties were evaluated in the same manner as in Example 1. Table 3 to Table 5 present the results.

### Example 3

A toner of Example 3 was obtained in the same manner as in Example 1, except that the ageing time in <Emulsification/Desolventization> of Example 1 was changed to 3 hours.

A (B)/(A) value in the pyrolysate of the toner and a nitrogen content in the surface of the toner were measured and various properties were evaluated in the same manner as in Example 1. Table 3 to Table 5 present the results.

### Example 4

A toner of Example 4 was obtained in the same manner as in Example 1, except that the ageing time in <Emulsification/Desolventization> of Example 1 was changed to 15 hours.

A (B)/(A) value in the pyrolysate of the toner and a nitrogen content in the surface of the toner were measured and various properties were evaluated in the same manner as in Example 1. Table 3 to Table 5 present the results.

### Example 5

A toner of Example 5 was obtained in the same manner as in Example 1, except that the amorphous polyester resin A1 used in <Preparation of Master Batch (MB)> and <Preparation of Oil Phase> of Example 1 was changed to the amorphous polyester resin A2.

A (B)/(A) value in the pyrolysate of the toner and a nitrogen content in the surface of the toner were measured and various properties were evaluated in the same manner as in Example 1. Table 3 to Table 5 present the results.

### Example 6

A toner of Example 6 was obtained in the same manner as in Example 1, except that [ethyl acetate solution of amorphous polyester resin pA1] used in <Preparation of Oil Phase> of Example 1 was changed to [ethyl acetate solution of amorphous polyester resin pA2].

A (B)/(A) value in the pyrolysate of the toner and a nitrogen content in the surface of the toner were measured and various properties were evaluated in the same manner as in Example 1. Table 3 to Table 5 present the results.

### Example 7

A toner of Example 7 was obtained in the same manner as in Example 1, except that [ethyl acetate solution of amorphous polyester resin pA1] used in <Preparation of Oil Phase> of Example 1 was changed to [ethyl acetate solution of amorphous polyester resin pA3].

A (B)/(A) value in the pyrolysate of the toner and a nitrogen content in the surface of the toner were measured and various properties were evaluated in the same manner as in Example 1. Table 3 to Table 5 present the results.

### Example 8

A toner of Example 8 was obtained in the same manner as in Example 1, except that [ethyl acetate solution of amorphous polyester resin pA1] used in <Preparation of Oil Phase> of Example 1 was changed to [ethyl acetate solution of amorphous polyester resin pA4].

A (B)/(A) value in the pyrolysate of the toner and a nitrogen content in the surface of the toner were measured and various properties were evaluated in the same manner as in Example 1. Table 3 to Table 5 present the results.

### Example 9

A toner of Example 9 was obtained in the same manner as in Example 1, except that [ethyl acetate solution of amorphous polyester resin pA1] used in <Preparation of Oil Phase> of Example 1 was changed to [ethyl acetate solution of amorphous polyester resin pA5].

A (B)/(A) value in the pyrolysate of the toner and a nitrogen content in the surface of the toner were measured and various properties were evaluated in the same manner as in Example 1. Table 3 to Table 5 present the results.

### Example 10

A toner of Example 10 was obtained in the same manner as in Example 1, except that [ethyl acetate solution of amorphous polyester resin pA1] used in <Preparation of Oil Phase> of Example 1 was changed to [ethyl acetate solution of amorphous polyester resin pA6].

A (B)/(A) value in the pyrolysate of the toner and a nitrogen content in the surface of the toner were measured and various properties were evaluated in the same manner as in Example 1. Table 3 to Table 5 present the results.

### Example 11

A toner of Example 11 was obtained in the same manner as in Example 1, except that [ethyl acetate solution of amorphous polyester resin pA1] used in <Preparation of Oil Phase> of Example 1 was changed to [ethyl acetate solution of amorphous polyester resin pA7].

A (B)/(A) value in the pyrolysate of the toner and a nitrogen content in the surface of the toner were measured and various properties were evaluated in the same manner as in Example 1. Table 3 to Table 5 present the results.

### Example 12

A toner of Example 12 was obtained in the same manner as in Example 1, except that [ethyl acetate solution of amorphous polyester resin pA1] used in <Preparation of Oil Phase> of Example 1 was changed to [ethyl acetate solution of amorphous polyester resin pA8].

A (B)/(A) value in the pyrolysate of the toner and a nitrogen content in the surface of the toner were measured and various properties were evaluated in the same manner as in Example 1. Table 3 to Table 5 present the results.

### Example 13

A toner of Example 13 was obtained in the same manner as in Example 1, except that [crystalline polyester resin dispersion liquid] was not blended and a total blending amount of [amorphous polyester resin A1] was 800 parts in <Preparation of Oil Phase> unlike in Example 1.

A (B)/(A) value in the pyrolysate of the toner and a nitrogen content in the surface of the toner were measured and various properties were evaluated in the same manner as in Example 1. Table 3 to Table 5 present the results.

### Example 14

A toner of Example 14 was obtained in the same manner as in Example 1, except that a total blending amount of [amorphous polyester resin A1] was 800 parts and a blending amount of [ethyl acetate solution of amorphous polyester resin pA1] was 100 parts in <Preparation of Oil Phase> unlike in Example 1.

A (B)/(A) value in the pyrolysate of the toner and a nitrogen content in the surface of the toner were measured and various properties were evaluated in the same manner as in Example 1. Table 3 to Table 5 present the results.

### Example 15

A toner of Example 15 was obtained in the same manner as in Example 1, except that a total blending amount of [amorphous polyester resin A1] was 820 parts and a blending amount of [ethyl acetate solution of amorphous polyester resin pA1] was 80 parts in <Preparation of Oil Phase> unlike in Example 1.

A (B)/(A) value in the pyrolysate of the toner and a nitrogen content in the surface of the toner were measured and various properties were evaluated in the same manner as in Example 1. Table 3 to Table 5 present the results.

### Comparative Example 1

A toner of Comparative Example 1 was obtained in the same manner as in Example 1, except that a total blending amount of [amorphous polyester resin A1] was 900 parts and [ethyl acetate solution of amorphous polyester resin pA1] was not contained in <Preparation of Oil Phase> unlike in Example 1.

A (B)/(A) value in the pyrolysate of the toner and a nitrogen content in the surface of the toner were measured and various properties were evaluated in the same manner as in Example 1. Table 3 to Table 5 present the results.

### Comparative Example 2

A toner of Comparative Example 2 was obtained in the same manner as in Example 1, except that isophoronediamine (2 parts) was contained as a hardening agent in <Preparation of Oil Phase> unlike in Example 1.

A (B)/(A) value in the pyrolysate of the toner and a nitrogen content in the surface of the toner were measured and various properties were evaluated in the same manner as in Example 1. Table 3 to Table 5 present the results.

### Comparative Example 3

A toner of Comparative Example 3 was obtained in the same manner as in Example 1, except that isophoronediamine (2 parts) was contained as a hardening agent in <Preparation of Oil Phase> and the aging time in <Emulsification/Desolventization> was 15 hours unlike in Example 1.

A (B)/(A) value in the pyrolysate of the toner and a nitrogen content in the surface of the toner were measured and various properties were evaluated in the same manner as in Example 1. Table 3 to Table 5 present the results.

### Comparative Example 4

A toner of Comparative Example 4 was obtained in the same manner as in Example 1, except that isophoronediamine (2 parts) was contained as a hardening agent in <Preparation of Oil Phase> and the aging time in <Emulsification/Desolventization> was 3 hours unlike in Example 1.

A (B)/(A) value in the pyrolysate of the toner and a nitrogen content in the surface of the toner were measured and various properties were evaluated in the same manner as in Example 1. Table 3 to Table 5 present the results.

### Comparative Example 5

A toner of Comparative Example 5 was obtained in the same manner as in Example 1, except that the aging time in

<Emulsification/Desolventization> was 2 hours unlike in Example 1.

A (B)/(A) value in the pyrolysate of the toner and a nitrogen content in the surface of the toner were measured and various properties were evaluated in the same manner as in Example 1. Table 3 to Table 5 present the results.

### Comparative Example 6

A toner of Comparative Example 6 was obtained in the same manner as in Example 1, except that isophoronediamine (2 parts) was contained as a hardening agent in <Preparation of Oil Phase> and the aging time in <Emulsification/Desolventization> was 2 hours unlike in Example 1.

A (B)/(A) value in the pyrolysate of the toner and a nitrogen content in the surface of the toner were measured and various properties were evaluated in the same manner as in Example 1. Table 3 to Table 5 present the results.

TABLE 3

| | | | | | Crystalline | | | | | | |
|---|---|---|---|---|---|---|---|---|---|---|---|
| | Amorphous polyester resin | | | | polyester | Release | | Hardening | | | |
| | Unmodified | | Prepolymer | | resin | agent | Pigment | agent | Aging | | Nitrogen |
| | | Part by | | Part by | Part by | Part by | Part by | Part by | time | B/A | content |
| | Kind | mass | Kind | mass | mass | mass | mass | mass | Time | — | Atom % |
| Ex. 1 | A1 | 750 | pA1 | 150 | 50 | 50 | 50 | 0 | 10 | 1 | 0.7 |
| Ex. 2 | A1 | 750 | pA1 | 150 | 50 | 50 | 50 | 0 | 5 | 0.8 | 0.8 |
| Ex. 3 | A1 | 750 | pA1 | 150 | 50 | 50 | 50 | 0 | 3 | 0.6 | 0.9 |
| Ex 4 | A1 | 750 | pA1 | 150 | 50 | 50 | 50 | 0 | 15 | 1.3 | 0.7 |
| Ex. 5 | A2 | 750 | pA1 | 150 | 50 | 50 | 50 | 0 | 10 | 1 | 0.7 |
| Ex. 6 | A1 | 750 | pA2 | 150 | 50 | 50 | 50 | 0 | 10 | 1 | 0.7 |
| Ex. 7 | A1 | 750 | pA3 | 150 | 50 | 50 | 50 | 0 | 10 | 1 | 0.7 |
| Ex. 8 | A1 | 750 | pA4 | 150 | 50 | 50 | 50 | 0 | 10 | 1 | 0.7 |
| Ex. 9 | A1 | 750 | pA5 | 150 | 50 | 50 | 50 | 0 | 10 | 1 | 0.7 |
| Ex. 10 | A1 | 750 | pA6 | 150 | 50 | 50 | 50 | 0 | 10 | 1 | 0.7 |
| Ex. 11 | A1 | 750 | pA7 | 150 | 50 | 50 | 50 | 0 | 10 | 1 | 0.7 |
| Ex. 12 | A1 | 750 | pA8 | 150 | 50 | 50 | 50 | 0 | 10 | 1 | 0.7 |
| Ex. 13 | A1 | 800 | pA1 | 150 | 0 | 50 | 50 | 0 | 10 | 1 | 0.7 |
| Ex. 14 | A1 | 800 | pA1 | 100 | 50 | 50 | 50 | 0 | 10 | 1 | 0.5 |
| Ex. 15 | A1 | 820 | pA1 | 80 | 50 | 50 | 50 | 0 | 10 | 1 | 0.3 |
| Comp. | A1 | 900 | None | 0 | 50 | 50 | 50 | 0 | 0 | 0 | 0 |
| Ex. 1 | | | | | | | | | | | |
| Comp. | A1 | 750 | pA1 | 150 | 50 | 50 | 50 | 2 | 10 | 2 | 1.1 |
| Ex. 2 | | | | | | | | | | | |
| Comp. | A1 | 750 | pA1 | 150 | 50 | 50 | 50 | 2 | 15 | 2.3 | 1 |
| Ex. 3 | | | | | | | | | | | |
| Comp. | A1 | 750 | pA1 | 150 | 50 | 50 | 50 | 2 | 3 | 1.4 | 1.2 |
| Ex. 4 | | | | | | | | | | | |
| Comp. | A1 | 750 | pA1 | 150 | 50 | 50 | 50 | 0 | 2 | 0.5 | 0.9 |
| Ex. 5 | | | | | | | | | | | |
| Comp. | A1 | 750 | pA1 | 150 | 50 | 50 | 50 | 2 | 2 | 1.3 | 1.3 |
| Ex. 6 | | | | | | | | | | | |

TABLE 4

| | | | TA15 | TA60 | TA600 |
|---|---|---|---|---|---|
| | Tg1st (° C.) | Tg2nd (° C.) | (−μC/g) | (−μC/g) | (−μC/g) |
| Ex. 1 | 44 | 23.9 | 36 | 37 | 38 |
| Ex. 2 | 43.9 | 23.9 | 37 | 36 | 36 |
| Ex. 3 | 43.6 | 23.7 | 38 | 35 | 35 |
| Ex. 4 | 43.8 | 23.6 | 33 | 33 | 34 |
| Ex. 5 | 34.8 | 20.1 | 35 | 35 | 34 |
| Ex. 6 | 44.9 | 23.7 | 35 | 37 | 37 |
| Ex. 7 | 44.3 | 24.4 | 36 | 37 | 36 |
| Ex. 8 | 44.7 | 22.5 | 36 | 36 | 37 |
| Ex. 9 | 45.7 | 25.0 | 36 | 37 | 37 |
| Ex. 10 | 45 | 25.7 | 36 | 36 | 37 |
| Ex. 11 | 46.8 | 28.5 | 36 | 38 | 38 |
| Ex. 12 | 48.3 | 31.3 | 36 | 37 | 38 |
| Ex. 13 | 43.7 | 41.0 | 37 | 38 | 38 |
| Ex. 14 | 45.1 | 24.8 | 41 | 40 | 39 |
| Ex. 15 | 45.5 | 24.5 | 42 | 40 | 40 |
| Comp. | 48 | 30.0 | 40 | 39 | 39 |
| Ex. 1 | | | | | |
| Comp. | 44.5 | 24.4 | 25 | 27 | 28 |
| Ex. 2 | | | | | |
| Comp. | 45 | 25.1 | 23 | 24 | 25 |
| Ex. 3 | | | | | |
| Comp. | 42.1 | 21.2 | 22 | 22 | 21 |
| Ex. 4 | | | | | |
| Comp. | 44.6 | 23.5 | 39 | 37 | 37 |
| Ex. 5 | | | | | |
| Comp. | 42.0 | 21.0 | 23 | 23 | 22 |
| Ex. 6 | | | | | |

TABLE 5

| | | | Heat | | | |
|---|---|---|---|---|---|---|
| | | | resistant | | | |
| | Lower limit | Upper limit of | storage | Chargeability | | |
| | of fixing | fixing | stability | TA15 | TA60 | TA600 |
| Ex. 1 | A | A | A | A | A | A |
| Ex. 2 | A | A | A | A | A | A |
| Ex. 3 | A | A | A | A | B | B |
| Ex. 4 | A | A | A | B | B | B |
| Ex. 5 | A | A | A | B | B | B |
| Ex. 6 | A | A | A | B | A | A |
| Ex. 7 | B | A | A | A | A | A |
| Ex. 8 | A | B | B | A | A | A |
| Ex. 9 | A | C | C | A | A | A |
| Ex. 10 | A | A | A | A | A | A |
| Ex. 11 | B | A | A | A | A | A |
| Ex. 12 | C | B | A | A | A | A |
| Ex. 13 | C | A | A | A | A | A |
| Ex. 14 | A | A | A | A | A | A |
| Ex. 15 | A | A | A | A | A | A |
| Comp. | A | D | D | A | A | A |
| Ex. 1 | | | | | | |
| Comp. | A | A | A | D | D | D |
| Ex. 2 | | | | | | |
| Comp. | A | A | A | D | D | D |
| Ex. 3 | | | | | | |
| Comp. | A | C | D | D | D | D |
| Ex. 4 | | | | | | |
| Comp. | A | C | D | A | A | A |
| Ex. 5 | | | | | | |
| Comp. | A | C | D | D | D | D |
| Ex. 6 | | | | | | |

Aspects of the present invention are as follows, for example.

<1> A toner including at least

a polyester resin,

wherein the polyester resin has a urethane bond and a urea bond,

wherein a ratio (B)/(A) between a nitrogen content (A) in a compound that is contained in a pyrolysate of the toner produced when the toner is pyrolyzed from 50° C. to 700° C. and has two isocyanate groups and a nitrogen content (B) in a compound that is contained in the pyrolysate and has one isocyanate group and one amino group satisfies 0.6≦(B)/(A)≦1.3, and

wherein a nitrogen content in a surface of the toner is from 0 atom % to 0.9 atom %.

<2> The toner according to <1>,

wherein the polyester resin includes a diol component and a cross-linking component,

wherein the diol component includes an aliphatic diol having 3 to 12 carbon atoms in an amount of equal to or greater than 50 mol % of the diol component, and

wherein the cross-linking component includes a trihydric or higher aliphatic alcohol.

<3> The toner according to <1> or <2>,

wherein a glass transition temperature (Tg1st) of the toner observed at a first temperature raise in differential scanning calorimetry (DSC) is from 20° C. to 50° C.

<4> The toner according to any one of <1> to <3>,

wherein a diol component constituting the polyester resin has an odd number of carbon atoms at main-chain moiety of the diol component, and has an alkyl group on a side chain of the diol component.

<5> The toner according to any one of <1> to <4>,

wherein the toner includes a crystalline polyester resin.

<6> The toner according to any one of <1> to <5>,

wherein a glass transition temperature (Tg2nd) of the toner observed at a second temperature raise in differential scanning calorimetry (DSC) is from 0° C. to 30° C., and

wherein Tg1st>Tg2nd is established.

<7> The toner according to any one of <1> to <6>,

wherein the toner is obtained by dissolving or dispersing in an organic solvent, a prepolymer that is a reaction product between an active hydrogen group of a polyester resin and a polyisocyanate, a polyester resin free of a urethane bond or a urea bond, a colorant, and a release agent, dispersing a resulting solution or dispersion liquid in an aqueous medium containing resin particles, removing the organic solvent after or while reacting the prepolymer by water, washing a resultant, and drying a resultant.

<8> A developer including

the toner according to any one of <1> to <7>.

<9> An image forming apparatus including:
an electrostatic latent image bearer;
an electrostatic latent image forming unit configured to form an electrostatic latent image over the electrostatic latent image bearer; and

a developing unit including a toner and configured to develop the electrostatic latent image formed over the electrostatic latent image bearer to form a visible image,

wherein the toner is the toner according to any one of <1> to <7>.

This application claims priority to Japanese application No. 2014-264606, filed on Dec. 26, 2014 and incorporated herein by reference and Japanese application No. 2015-116436, filed on Jun. 9, 2015.

What is claimed is:

1. A toner comprising
a polyester resin,
wherein the polyester resin comprises a urethane bond and a urea bond, wherein a ratio (B)/(A) between a nitrogen content (A) in a compound that is comprised in a pyrolysate of the toner produced when the toner is pyrolyzed from 50° C. to 700° C. and comprises two isocyanate groups and a nitrogen content (B) in a compound that is comprised in the pyrolysate and comprises one isocyanate group and one amino group satisfies 0.6≦(B)/(A)≦1.3, and
wherein a nitrogen content in a surface of the toner is from 0 atom % to 0.9 atom %.

2. The toner according to claim 1,
wherein the polyester resin comprises a diol component and a cross-linking component,
wherein the diol component comprises an aliphatic diol having 3 to 12 carbon atoms in an amount of equal to or greater than 50 mol % of the diol component, and
wherein the cross-linking component comprises a trihydric or higher aliphatic alcohol.

3. The toner according to claim 1,
wherein a glass transition temperature (Tg1st) of the toner observed at a first temperature raise in differential scanning calorimetry (DSC) is from 20° C. to 50° C.

4. The toner according to claim 1,
wherein a diol component comprised in the polyester resin comprises an odd number of carbon atoms at main-chain moiety of the diol component, and comprises an alkyl group on a side chain of the diol component.

5. The toner according to claim 1, comprising
a crystalline polyester resin.

6. The toner according to claim 3,
wherein a glass transition temperature (Tg2nd) of the toner observed at a second temperature raise in differential scanning calorimetry (DSC) is from 0° C. to 30° C., and
wherein Tg1st>Tg2nd is established.

7. The toner according to claim 1,
wherein the toner is obtained by dissolving or dispersing in an organic solvent, a prepolymer that comprises a reaction product between an active hydrogen group of a polyester resin and a polyisocyanate, a polyester resin free of a urethane bond or a urea bond, a colorant, and a release agent, dispersing a resulting solution or dispersion liquid in an aqueous medium that comprises resin particles, removing the organic solvent after or while reacting the prepolymer by water, washing a resultant, and drying a resultant.

8. A developer comprising
the toner according to claim 1.

9. An image forming apparatus comprising:
an electrostatic latent image bearer;
an electrostatic latent image forming unit configured to form an electrostatic latent image over the electrostatic latent image bearer; and a developing unit that comprises a toner and is configured to develop the electrostatic latent image formed over the electrostatic latent image bearer to form a visible image,
wherein the toner is the toner according to claim 1.
